(19) United States
(12) Patent Application Publication
(10) Pub. No.: US 2023/0397527 A1
(43) Pub. Date: Dec. 14, 2023

(54) STRING TRIMMER HEAD AND STRING TRIMMER

(71) Applicant: Nanjing Chervon Industry Co., Ltd., Nanjing (CN)

(72) Inventor: Jianpeng Guo, Nanjing (CN)

(21) Appl. No.: 18/454,611

(22) Filed: Aug. 23, 2023

Related U.S. Application Data
(63) Continuation-in-part of application No. 17/551,282, filed on Dec. 15, 2021.
Application No. 17/551,282 is a continuation of application No. PCT/CN2020/096353, filed on Jun. 16, 2020.

(30) Foreign Application Priority Data
Jun. 17, 2019 (CN) 201910520911.X
Oct. 13, 2022 (CN) 2022112510990.3

(51) Int. Cl. A01D 34/416

(52) U.S. Cl. CPC A01D 34/4162; A01D 34/4163

(57) ABSTRACT

A string trimmer head includes a spool, a head housing, an automatic line release device, and an operating member. The automatic line release device is configured to enable the spool and the head housing to generate a first relative rotation so that the string trimmer head releases a string trimmer line, where the string trimmer line has an effective length extending out of the accommodation space; and the automatic line release device is further configured to make the string trimmer head release the string trimmer line when the effective length of the string trimmer line is less than a preset value. The operating member is configured to be operable by a user to drive the spool and the head housing to generate a second relative rotation so that the string trimmer line is wound around the spool.

### RELATED APPLICATION INFORMATION

This application is a continuation-in-part of U.S. application Ser. No. 17/551,282, filed on Dec. 15, 2021, which application is a continuation of International Application Number PCT/CN2020/096353, filed on Jun. 16, 2020, through which this application also claims the benefit under 35 U.S.C. § 119(a) of Chinese Patent Application No. CN 201910520911.X, filed on Jun. 17, 2019.

This application also claims the benefit under 35 U.S.C. § 119(a) of Chinese Patent Application No. CN 202211251099.3, filed on Oct. 13, 2022.

Each of these applications is incorporated herein by reference in its entirety.

### TECHNICAL FIELD

The present application relates to a garden tool and, in particular, to a string trimmer head and a string trimmer.

### BACKGROUND

As a garden tool, a string trimmer is especially suitable for trimming grass such as a villa lawn and a garden lawn. The string trimmer includes a string trimmer head and a string trimmer line, where the string trimmer head drives the string trimmer line to rotate at a high speed to cut vegetation. Generally, a spool for the string trimmer line to be wound around is provided in the string trimmer head. Currently, some string trimmers on the market have the functions of automatic line release and automatic line winding, that is, the string trimmer head may automatically wind the string trimmer line onto the spool and may automatically release the string trimmer line from the spool after the string trimmer line becomes shorter due to wear. However, in some working environments, the automatic line winding function of the string trimmer may fail for reasons such as a motor failure. At this time, the maintenance of the string trimmer head will prolong a working time and reduce working efficiency.

This part provides background information related to the present application, which is not necessarily the existing art.

### SUMMARY

A first aspect of the present application provides a string trimmer head including a spool, a head housing, an automatic line release device, and an operating member. A string trimmer line is capable of being wound around the spool. The head housing has an accommodation space capable of accommodating at least part of the spool. The automatic line release device is configured to enable the spool and the head housing to generate a first relative rotation so that the string trimmer head releases the string trimmer line, where the string trimmer line has an effective length extending out of the accommodation space; and the automatic line release device is further configured to make the string trimmer head release the string trimmer line when the effective length of the string trimmer line is less than a preset value. The operating member is configured to be operable by a user to drive the spool and the head housing to generate a second relative rotation so that the string trimmer line is wound around the spool.

A second aspect of the present application provides a string trimmer including a string trimmer head and a motor for driving the string trimmer head to rotate, where the string trimmer head includes a spool, a head housing, an automatic line release device, and an operating member. A string trimmer line is capable of being wound around the spool. The head housing has an accommodation space capable of accommodating at least part of the spool. The automatic line release device is configured to enable the spool and the head housing to generate a first relative rotation so that the string trimmer head releases the string trimmer line, where the string trimmer line has an effective length extending out of the accommodation space; and the automatic line release device is further configured to make the string trimmer head release the string trimmer line when the effective length of the string trimmer line is less than a preset value. The operating member is configured to be operable by a user to drive the spool and the head housing to generate a second relative rotation so that the string trimmer line is wound around the spool.

In some examples, the string trimmer further includes the motor for driving the string trimmer head to rotate, and the automatic line release device includes a transmission member. The transmission member has, relative to the spool, a first position for preventing a relative rotation between the spool and the head housing and a second position for allowing the relative rotation between the spool and the head housing. When the transmission member is at the first position, the string trimmer head is in a trimming state and the motor has a first rotational speed. When the transmission member is at the second position, the string trimmer head is in an autonomous line release state, the motor has a second rotational speed with a difference from the first rotational speed, and the spool and the head housing generate the first relative rotation to release the string trimmer line. When the effective length of the string trimmer line is greater than or equal to the preset value, the transmission member is at the first position; and when the effective length of the string trimmer line is less than the preset value, the transmission member is at the second position.

A third aspect of the present application provides a string trimmer head including a spool, a head housing, and an automatic line release device. A string trimmer line is capable of being wound around the spool. The head housing has an accommodation space capable of accommodating at least part of the spool. The automatic line release device is configured to enable the spool and the head housing to generate a first relative rotation so that the string trimmer head releases the string trimmer line, where the string trimmer line has an effective length extending out of the accommodation space; and the automatic line release device is further configured to make the string trimmer head release the string trimmer line when the effective length of the string trimmer line is less than a preset value. The string trimmer head further includes a first guide structure and a second guide structure. The first guide structure is formed on or connected to the head housing and configured to guide the string trimmer line to penetrate through the head housing without entering the spool during threading. The second guide structure is formed on or connected to the spool and configured to guide the string trimmer line to leave the first guide structure and be wound around the spool through a relative rotation between the spool and the head housing during winding.

The string trimmer head and the string trimmer provided by the present application not only have automatic line release and automatic winding functions but also allow the user to perform manual winding so that the user can continue to use the string trimmer head and the string trimmer normally after the automatic winding function of the string trimmer head fails.

### BRIEF DESCRIPTION OF THE DRAWINGS

FIG. 1 is a perspective view of a string trimmer;

FIG. 2 is a section view of a trimming head for the string trimmer of FIG. 1;

FIG. 3 is an explosion view of the trimming head for the string trimmer of FIG. 1;

FIG. 4 is an explosion view of the trimming head for the string trimmer on another view;

FIG. 5 is a section view of the spool of the string trimmer in FIG. 3;

FIG. 6 is a perspective view of a spool and a transmission part of the string trimmer of FIG. 3;

FIG. 7 is a top view of a head housing, the spool and the transmission part of the string trimmer of FIG. 3;

FIG. 8 is a section view of the head housing, the spool and the transmission part of the string trimmer of FIG. 3;

FIG. 9 is a top view of the head housing of the string trimmer of FIG. 3;

FIG. 10 is a force analysis diagram for any point on a first teeth of the working head of the string trimmer of FIG. 8;

FIG. 11 is a section view of the working head, the spool and the transmission part of the string trimmer of FIG. 3 when the transmission part is between a first inner tooth and a second inner tooth;

FIG. 12 is a section view of the trimming head, the spool and the transmission part of the string trimmer of FIG. 3 when the transmission part is pushed back by the second inner tooth; and

FIG. 13 is a section view of the head housing, the spool and the transmission member of the string trimmer in FIG. 12 when the transmission member is pushed back by the second teeth; and in the view, part of the first teeth and the plurality of second teeth are deleted.

FIG. 14 is a perspective view of a string trimmer of the present application;

FIG. 15 is an exploded view of a string trimmer head and a drive device of the string trimmer of FIG. 14;

FIG. 16 is an exploded view of a string trimmer head of the string trimmer of FIG. 14;

FIG. 17 is an exploded view of a string trimmer head of the string trimmer of FIG. 14 from another angle;

FIG. 18 is a perspective view of a spool and a transmission member of the string trimmer of FIG. 16;

FIG. 19 is a cross-sectional view of a head housing, a spool, and a transmission member of the string trimmer of FIG. 16 in a trimming state;

FIG. 20 is a cross-sectional view of a head housing, a spool, and a transmission member of the string trimmer of FIG. 16 in a line release state;

FIG. 21 is a perspective view of a spool of the string trimmer of FIG. 16;

FIG. 22 is a perspective view of a lower housing of a head housing of a string trimmer of the present application;

FIG. 23 is a plan view of the lower housing of FIG. 22; and

FIG. 24 is a plan view of a lower housing of a head housing of another string trimmer of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

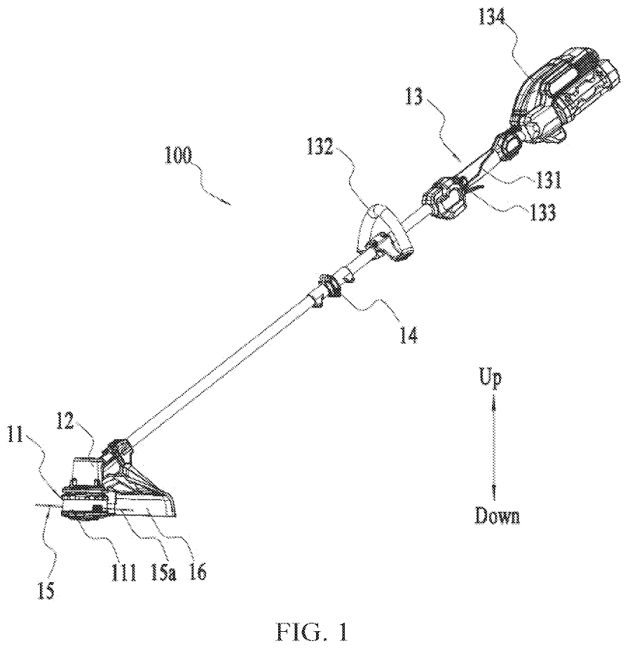

A string trimmer 100 shown in FIG. 1 includes a trimming head 11, a driving device 12, an operating device 13, and a connecting device 14.

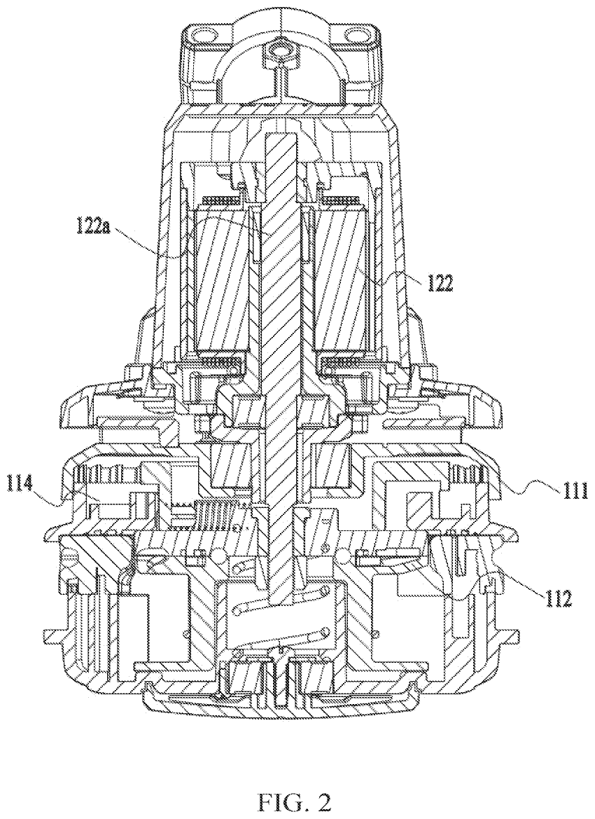

As shown in FIG. 1 to FIG. 2, the trimming head 11 is used to install a trimming line 15 for realizing the trimming function. The driving device 12 is used to provide a rotational power to the trimming head 11. The driving device 12 includes a motor 122 and a first housing 121. The motor 122 is arranged in the first housing 121. The motor 122 drives the trimming head 11 to rotate by a rotation axis 101. The operating device 13 includes a handle 131, an auxiliary handle 132, a main switch 133 and a second housing 134. The handle 131 and the auxiliary handle 132 are used for the users to hold by two hands separately, so that the string trimmer 100 can be operated more stably. The main switch 133 can be positioned on the handle 131, and the user can directly operate the main switch 133 to control the string trimmer 100 to trim grass when holding the handle 131. The second housing 134 is for forming a coupling portion that is combined with the power supply device. For example, the coupling portion can be combined with a battery pack to supply power to the string trimmer 100. In this example, the handle 131 and the second housing 134 are formed separately. In some other examples, the handle 131 can also be integrally formed with the second housing 134. The connecting device 14 includes a connecting rod for connecting the first housing 121 and the second housing 134. The auxiliary handle 132 is also installed to the connecting rod, and the auxiliary handle 132 is also located between the first housing 121 and the second housing 134. The string trimmer 100 further includes a guard 16 which is at least partially surrounding the trimming head 11, which in turn prevent the debris from flying to the direction where the user or operator stands when the string trimmer 11 is trimming the grass.

In order to facilitate the description of the technical solution of the present disclosure, a upper side and a lower side are defined as shown in FIG. 1, wherein the driving device 12 is arranged on the upper side of the trimming head 11, and the trimming head 11 is arranged on the lower side of the driving device 12.

The trimming head 11 also includes ahead housing 111, a spool 112 and a linkage device 113. The head housing 111 is formed with an accommodating space 114 around the rotation axis 101 and the accommodating space 114 can accommodate at least a part of the spool 112. The side of the head housing 111 forming the accommodating space 114 is the inner side of the head housing 111, and the side of the head housing 111 opposite to the inner side is outside.

As shown in FIG. 1 to FIG. 4, the spool 112 is disposed in the accommodating space 114. That is, the spool 112 is disposed on the inner side of the head housing 111. The spool 112 is used for winding the trimming line 15, and the trimming line 15 is used for trimming grass. The head housing 111 also forms an outer threading aperture 111a for the trimming line 15 to extend to the outside of the head housing 111, and the amount of the outer threading apertures 111a is two. The spool 112 also forms an inner threading aperture 112a. When the inner threading aperture 112a and the outer threading aperture 111a are located in the same radial direction, the trimming line 15 can pass through the outer threading aperture 111a and the inner threading aperture 112a in sequence. Exemplarily, the spool 112 is also formed with a threading channel 112d which connects two inner threading apertures 112a and allows the trimming line 15 to pass through. In fact, the threading channel 112d connects any two inner threading apertures on the spool, and the threading channel is arranged to extend along a curve. When the users need to supplement feed the trimming line 15, the users can insert the trimming line 15 through the outer threading aperture 111a into the accommodating space 114, then pass the threading channel 112d through the inner threading aperture 112a, and to the outside of the head housing 111 from the outer threading aperture 111a on the opposite side. When the trimming line 15 needs to be wound around the spool 112, users do not need to open the head housing 111. It is possible to directly extend the trimming line 15 into the head housing 111 and then wind the trimming line 15 on the spool 112 through the relative rotation of the spool 112 and the head housing 111. Such type of trimming head 11 is usually called an external inserted winding head.

The part of the trimming line 15 extending through the outer threading aperture 111a to the outside of the head housing 111 is defined as an effective portion 15a of the trimming line 15, and the effective portion 15a of the trimming line 15 trims weeds by high-speed rotation. In order to trim weeds within the expected area, the length of the effective portion 15a of the trimming line 15 should reach a preset value. That is, the length of the effective portion 15a of the trimming line 15 should be greater than or equal to the preset value. When the length of the effective portion 15a of the trimming line 15 is less than the preset value, the cutting efficiency of the trimming line 15 may be reduced because the effective portion 15a of the trimming line 15 is relatively short. In order to keep the length of the effective portion 15a of the trimming line 15 to be greater than or equal to the length range of the preset value, the string trimmer 100 in this example can realize it that the linkage device 113 controls the trimming line 15 to be autonomously fed to a length range greater than or equal to the preset value when the length of the effective portion 15a of the trimming line 15 is lower than the preset value. In order to prevent the extension length of the trimming line 15 from being too long and causing interference with the guard 16, the effective portion 15a of the trimming line 15 is actually less than or equal to a limit value. Within this limit, on one hand, the trimming line 15 can effectively mowing the grass and maintain a high mowing efficiency; on the other hand, the trimming line 15 will not interfere with the guard 16, so that mowing can be continued.

The linkage device 113 is used to control whether the trimming head 11 is feeding or not. The linkage device 113 has a first equilibrium state that makes the trimming head 11 to be unable to feed. At this time, the trimming head 11 is in a working state. The linkage device 113 also has a second equilibrium state in which the trimming head 11 can feed the trimming line, and the trimming head 11 is in a autonomously feeding state at this time. In this example, the linkage device 113 can autonomously identify a effective length of the trimming line 15 and can autonomously adjust the trimming head 11 to enter the first equilibrium state or the second equilibrium state according to the length of the effective portion 15a of the trimming line 15, that is to adjust the trimming head 11 to autonomously enter the working state or the autonomously feeding state. It needs to be emphasized that, for the linkage device 113, the autonomous reorganization and adjustment of the working mode of the trimming head 11 is based on the linkage device 113 itself, and there is no need to accept an input from an outside or an indication signal for feeding the line or trimming. The indication signal mentioned here includes a signal that causes the linkage device 113 to switch modes due to an external force, electrical signal, magnetic force, or other force generated by the outside on the trimming head 11. In some common indication signals, it generally includes: tapping the shell of the trimming head 11 to make the spool 112 and the head housing 111 produce a speed difference to feed the trimming line; adjusting the speed through a switch to make the spool 112 and the head housing 111 to produce a speed difference to feed the trimming line; inducting the current change through a sensor induces in the motor to cause a speed difference between the spool 112 and the head housing 111 to feed the trimming line. In addition, the rotation speed of the trimming head 11 in this example is constant, and there is no need to change the rotation speed of motor 122 to make the spool 112 to have a speed change to obtain the speed difference between the head housing 111 and the spool 112 to perform line feeding.

Exemplarily, when the linkage device 113 is in the first equilibrium state, the spool 112 and the head housing 111 are relatively static. In this way, the spool 112 and the head housing 111 will be driven by a motor shaft 122a to rotate synchronously, so that at this time the length of the trimming line 15 wound on the spool 112 extending from the effective portion 15a of the head housing 111 will not change. That is, the trimming line 15 cannot be released, and the trimming head 11 is in a normal working state at this time. When the linkage device 113 is in the second equilibrium state, a relative movement occurs between the spool 112 and the head housing 111. In this way, the trimming line 15 is thrown out relative to the spool 112 under the action of its own centrifugal force, so that the trimming line 15 is released, and the length of the effective portion 15a of the trimming line 15 will increase.

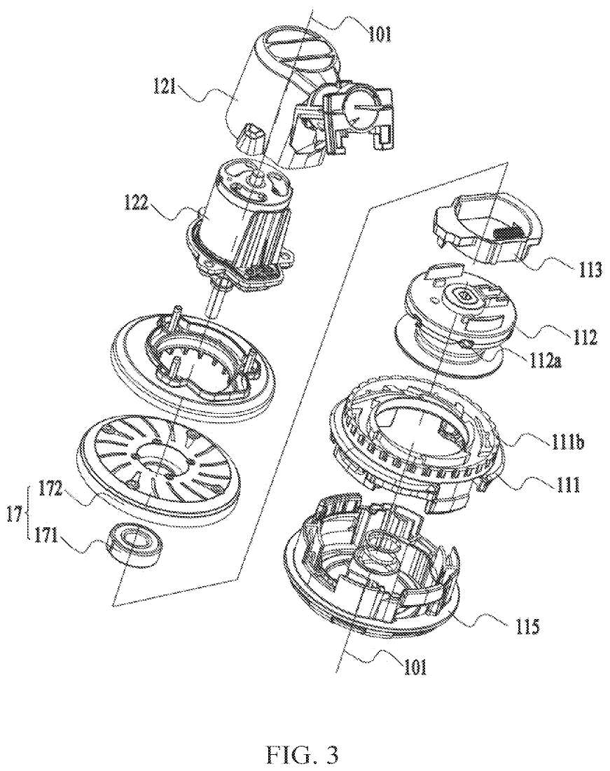

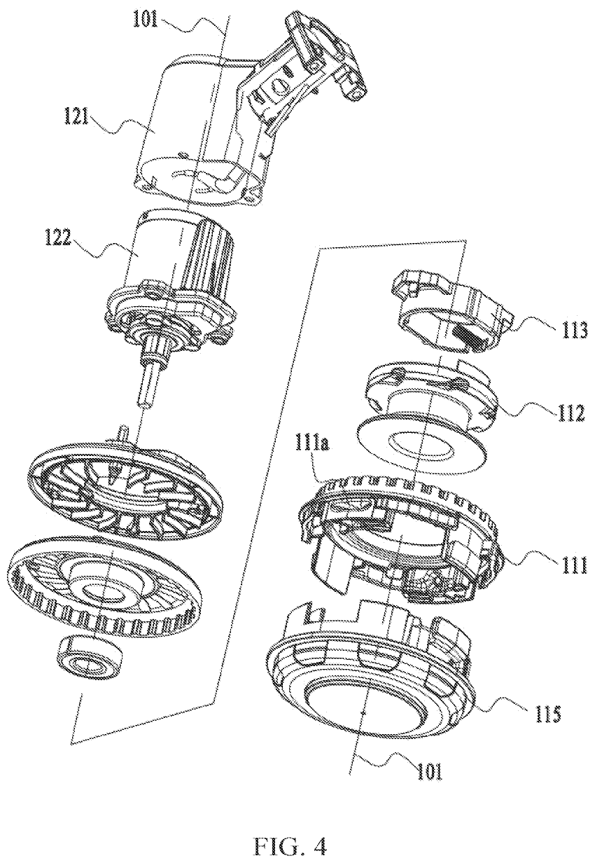

As shown in FIGS. 3 to 4, in some examples, the linkage device 113 includes a transmission member 113a that can move freely between the spool 112 and the head housing 111. When the linkage device 113 is in the first equilibrium state, the transmission member 113a rotates synchronously with the spool 112. At this time, the transmission member 113a is in a first position, and the transmission member 113a also mates with the head housing 111 to drive the head housing 111 to rotate synchronously with the spool 112, and the motor has a first rotation speed at this time; When the linkage device 113 is in the second equilibrium state, the transmission member 113a rotates with the spool 112, and at the same time, the transmission member 113a is disengaged from the head housing 111. At this moment, the transmission member 113a is in a second position. The spool 112 and the head housing 111 can move relative to each other, and the motor 122 has a first rotation speed at this time. As an implementation method, when the transmission member 113a is in the first position or the second position, the ratio of the absolute value of the difference between the first rotation speed and the second rotation speed of the motor 122 to the first rotation speed is greater than or equal to 0 and less than or equal to 0.15. As an implementation method, when the transmission member 113a is in the first position or the second position, the ratio of the absolute value of the difference between the first rotation speed and the second rotation speed of the motor 122 to the first rotation speed is greater than or equal to 0 and less than or equal to 0.1. In fact, in a better state, when the transmission member 113a is in the first position or the second position, the ratio of the absolute value of the difference between the first rotation speed and the second rotation speed of the motor 122 to the first rotation speed is greater than or equal to 0 and less than or equal to 0.05, and the ratio of the absolute value of the difference between the first rotation speed and the second rotation speed of the motor 122 to the first rotation speed approaches zero infinitely. Through such a setting, it is realized that the trimming head 11 has no differential speed change and the autonomous line-feeding, that is, the automatic line-feeding in the true sense. When the driving member 113a of the trimming head 11 is displaced, or the trimming line 15 is released to a preset length due to abrasion in the process of autonomous line-feeding, it all generates a preset force. So when the trimming head 11 is under the influence of the load of the trimming line 15 and the relative movement of the internal parts of the trimming head 11, the rotation speed of the trimming head 11 itself has a preset change, so that the trimming head 11 cannot always rotate with a theoretical absolute constant speed, which resulting in a second speed that is different from the first speed. Here, within the allowable range of the above deviation, it is assumed that the change from the first speed to the second speed of the trimming head 11 is still within the scope of the aforementioned uniform rotation, and the switch of the trimming head 11 between the autonomous line-feeding state and the working state does not depend on the aforementioned changes in speed.

Optionally, in the direction of a straight line 102 which is substantially perpendicular to the direction of the rotation axis 101 or obliquely intersecting the rotation axis 101, the transmission member 113a is arranged between the spool 112 and the head housing 111 along the direction of the straight line 102. The motor shaft 122a and the spool 112 are configured to rotate synchronously. The transmission member 113a is provided with a transmission hole through which the spool 112 is sleeved and can rotate synchronously with the spool 112. In this way, when the motor shaft 122a drives the spool 112 to rotate, the transmission member 113a can rotate with the spool 112 synchronously. In fact, a limiting portion 112b is formed or coupled connected to with the spool 112, and the limiting portion 112b can limit the circumferential displacement of the transmission member 113a around the direction of the rotation axis 101. Exemplarily, the limiting portion 112b is a pair of protrusions symmetrically arranged with respect to a symmetry plane passing through the straight line 102. The transmission member 113a can be limited to the limiting portion 112b when it is sleeved to the spool 112 in the direction of the rotation axis 101, and only radial displacement in the linear direction perpendicular to the rotation axis 101 can be produced. The transmission member 113a is asymmetrical with respect to the symmetry plane passing through the rotation axis 101 in terms of mass distribution. Optionally, a center of mass G of the transmission member 113a deviates from the symmetry plane. The center of mass G of the transmission member 113a deviates from the rotation axis 101, so that when the trimming head 11 is driven to rotate by the motor 122, the transmission member 113a is subjected to a centrifugal force that makes it to have a tendency to move from the first position to the second position. When rotating around the axis of rotation 101, a resistance against centrifugal force is applied to the transmission member 113a to prevent the transmission member from moving from the first position to the second position. A biasing element 113b is also provided between the transmission member 113a and the spool 112, and the biasing element 113b can be a coil spring.

Optionally, a receiving groove 112c is formed and extending on the spool 112, and the coil spring is at least partially disposed in the receiving groove 112c. One end of the coil spring abuts against the bottom of the receiving groove 112c, and the other end abuts the transmission member 113a. The center of mass of the transmission member 113a and the coil spring are arranged on two sides of the rotation axis 101. In addition, the limiting portion 112b and the receiving groove 112c mate to form a sliding rail for the transmission member 113a to slide. That is, the transmission member 113a also forms a slidable connection with the spool 112. When the transmission member 113a rotates with the spool 112, the transmission member 113a will generate a centrifugal force, and the transmission member 113a is also subjected to a biasing force of the biasing element 113b. The biasing force and the centrifugal force are in opposite direction. The centrifugal force and the biasing force can both be in the direction of the first straight line 102. The direction in which the transmission member 113a and the spool 112 constituting the sliding may also be along the direction of the straight line 102. The center of mass of the transmission member 113a and the biasing element 113b are respectively arranged on two sides of a plane passing through the rotation axis 101 and perpendicular to the first straight line 102. In some examples, when the transmission member 113a is on the movement in the direction of the first straight line 102 relative to the spool 112, it is also affected by a friction force between the transmission member 113a and the spool 112. The friction force can effectively prevent the biasing element 113b from overcoming the centrifugal force, and prevent the linkage device 113 from being overly flexible and causing the misfeeding of the line.

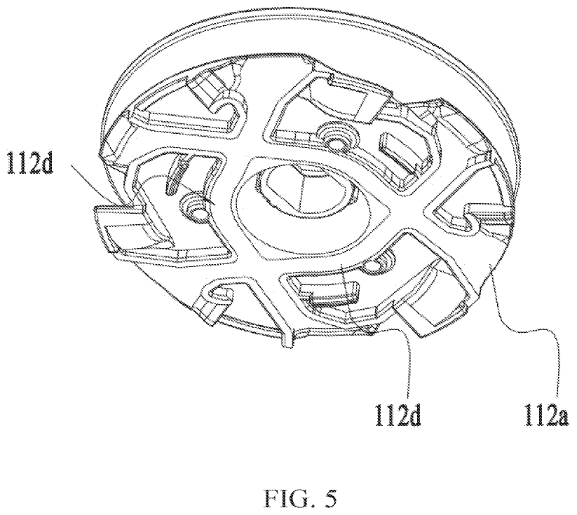

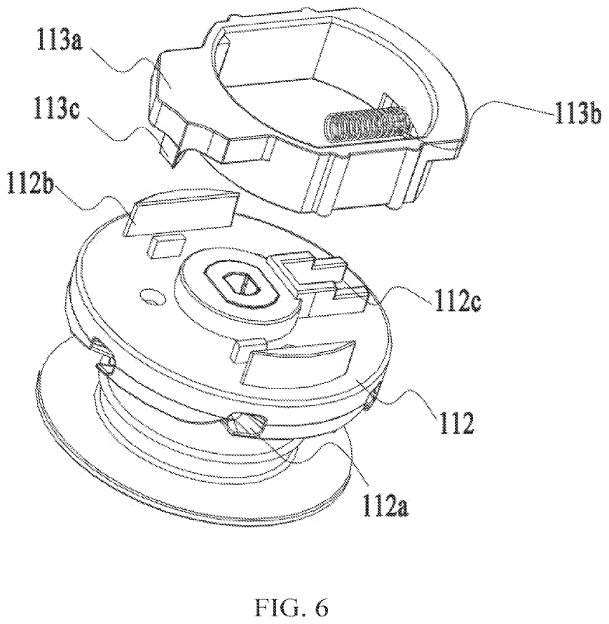

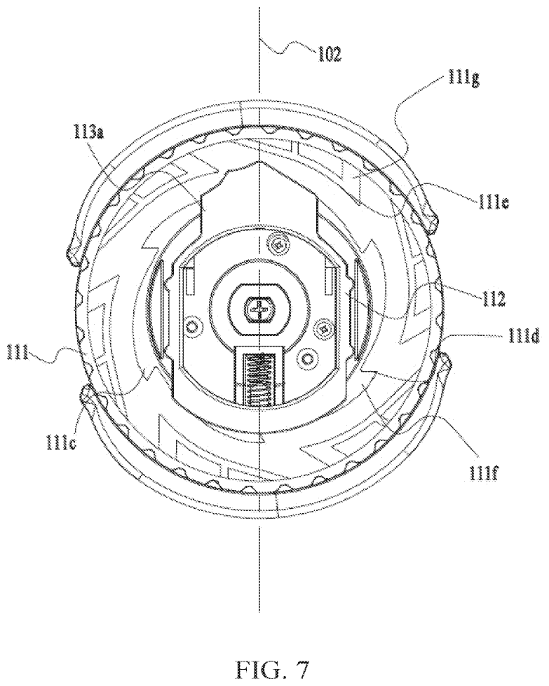

As shown in FIGS. 3 to 7, in the present example, the head housing 111 forms the accommodation space 114 mentioned above around the rotation axis 101, the spool 112 is at least partially disposed in the accommodation space 114 formed by the head housing 111, and the transmission member 113a is at least partially located in the accommodating space 11. Exemplarily, an upper bottom 111b is formed on the end of the head housing 111 near the motor 122 in the direction of the rotation axis 101. The upper bottom 111b does not enclose the accommodating space 114, and the accommodating space 114 is partially opened upward, so that the motor shaft 122a passes through the upper bottom 111b and extends into the accommodation space 114, and the transmission member 113a partially protrudes out of the head housing 111. The head housing 111 also form a mating portion 111c that can be driven by the transmission member 1113a, and the transmission member 113a is formed with a driving portion 113c that mates with the mating portion 111c. When the driving portion 113c is mated with the mating portion 111c, a force can be transmitted between the transmission member 113a and the head housing. Optionally, the mating portion 111c includes a mating surface 111d and a return surface 111e, wherein the mating surface 111d is used to contact the driving portion 113c to apply a reacting force to the driving portion 113c; and the return surface 111e is used to contact the driving portion 113c. When the driving portion 113c mates with the mating surface 111d, the trimming head 11 is in the working state; when the driving portion 113c is mated with the return surface 11e, the trimming head 11 is in an autonomous line-feeding state.

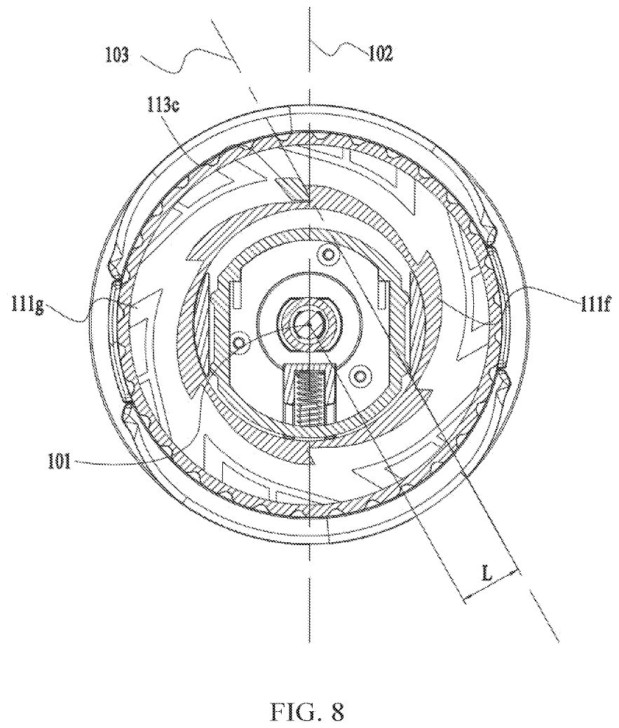

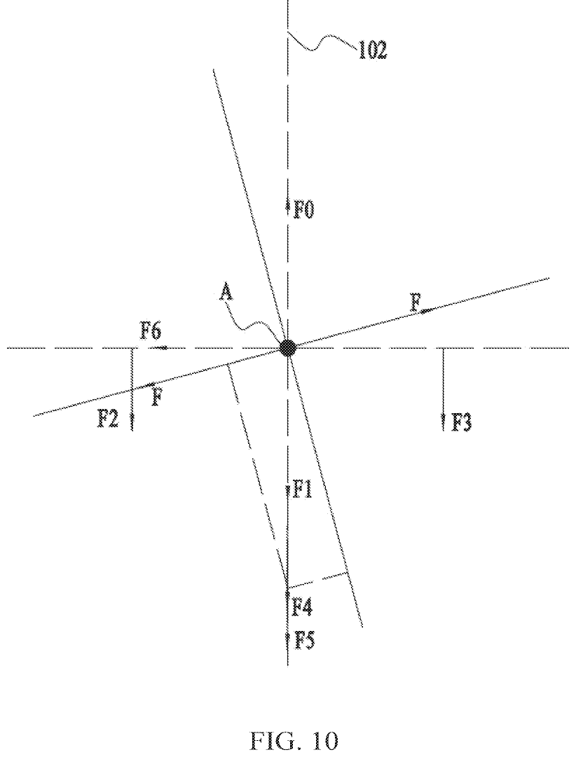

As shown in FIGS. 8 to 10, an inner ring and an outer ring are formed in the direction where the upper bottom 111b extends toward the motor 122. Both the inner ring and the outer ring are formed around the rotation axis 101. The inner ring is formed with first teeth 111f, and the first teeth 111f are external teeth formed on the inner ring and protruding toward the outer ring. The outer ring is formed with second teeth 111g, and the second teeth 111g are internal tooth formed on the outer ring and protruding toward the inner ring. Wherein, the first teeth 111f constitutes or forms the above mating surface 111d, and the second teeth 111g constitutes or forms the above return surface 111e. Wherein the number of the first teeth 111f is multiple, and the number of the second teeth 111g is also multiple. In the circumferential direction around the rotation axis 101, the first teeth 111f and the second teeth 111g are staggered from each other. That is, the first teeth 111f and the second teeth 111g are not arranged in a diameter direction perpendicular to the rotation axis 101 at the same time. The transmission member 113a is formed with a driving portion 113c that can mate with first teeth 111f or second teeth 111g. The driving portion 113c on the transmission member 113a can be configured as an engaging tooth that mates with the first teeth 111f and the second teeth 111g. In this example, the driving portion 113c and the biasing element 113b are arranged on two sides of the transmission member 113a respectively. That is, the center of mass of the driving portion 113c and the transmission member 113a are arranged on the same side of the rotation axis 101.

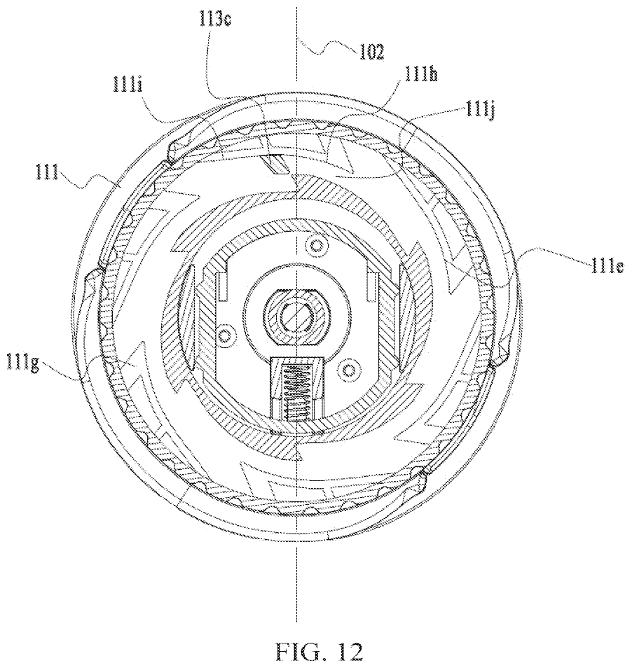

As shown in FIG. 12, when the driving portion 113c of the transmission member 113a is engaged with the plurality of first teeth 111f or the plurality of second teeth 111g and the motor shaft 122a rotates in the first rotation direction, that is, when the motor shaft 122a rotates clockwise, the transmission member 113a makes the head housing 111 to be relative static to the spool 112, that is, there is no relative movement between the spool 112 and the head housing 111 at this time. It can be considered that the linkage device 113 is in the first equilibrium state at this time, and the string trimmer 100 is in the working state of normal grass trimming. As shown in FIG. 12, when the driving portion 113c of the transmission member 113a is separated from the first teeth 111f and the second teeth 11g, the whole composed of the transmission member 113a and the spool 112 can move relative to the head housing 111. In this example, the direction of the movement of the spool 112 relative to the head housing 111 is consistent with the direction in which the string trimmer 100 trims grass. That is, the direction of the movement of the spool 112 relative to the head housing 111 is clockwise, that is, the spool 112 can now produce a relative movement relative to the head housing 111, it can be considered that the linkage device 113 at this time is in the second equilibrium state, that is, the cutting head 11 is in the autonomously line-feeding state.

In this example, a damping device 17 is also provided, and the damping device 17 has a damping spool 112 or head housing 111 to rotate and enables the elative rotation between the spool 112 and the head housing 111. Exemplarily, the damping device 17 may be set as a limiting pin for restricting the rotation of the head housing 111 or the spool 112, which can be inserted into a limiting hole reserved on the head housing 111 or the spool 112 to limit the rotation of the head housing 111 or the spool 112. As another implementation, the damping device 17 can also be configured as a friction element which can contact the spool 112 or the head housing 111, so that a relative motion between the head housing 111 and the spool 112 is caused by the speed difference. As another implementation, the damping device 17 can also be configured to include a one-way bearing 171 and a rotating support 172; wherein the one-way bearing 171 can make the two parts or parts connected to it rotate relatively only in one rotation direction, but cannot rotate relatively in another rotation direction. The function of the rotating support 172 is to rotatably connect a portion of the cutting head 11 and form a support for its rotation. The rotating support can be the first housing 121 of the string trimmer 100 that houses the motor 122, and it can also be other components fixedly coupled with the housing 121, such as the guard 16. Optionally, the one-way bearing 171 is arranged between the rotating support 172 and the head housing 111 so that they can form a one-way rotating connection. That is, when the rotating support 172 is used as a reference substance, the head housing 111 can rotate in one of the rotation directions, but cannot rotate in another direction. The motor shaft 122a is connected to the spool 112 in a non-rotational manner so that the spool 112 can rotate in both directions relative to the rotating support. That is, when the rotating support 172 is used as the reference substance, the spool 112 can rotate forward and reverse.

Based on the above hardware, when the motor 122 rotates forward, the motor shaft 122a drives the spool 112 to rotate clockwise. At this time, the transmission member arranged on the spool 112 engages with the first teeth 111f to achieve torque transmission, and at the same time, a one-way circumferential drive is set to make the head housing 111 rotate relative to the supporting member 172 (that is relative to the entire string trimmer 100) and be able to rotate forward. Then, at this time, the spool 112 and the head housing 111 rotate synchronously, and the string trimmer 100 can execute the trimming mode. When the motor 122 rotates reversely, the motor shaft 122a drives the spool 112 to reverse. The head housing 111 make the spool 112 and the head housing 111 to move relative to each other because the one-way bearing 171 prevents the head housing 111 from reversing. At this time, the driving portion 113c on the transmission member is disengaged from the first teeth 111f due to the reverse rotation of the motor 122, so that the string trimmer 100 can perform an autonomous line-feeding mode.

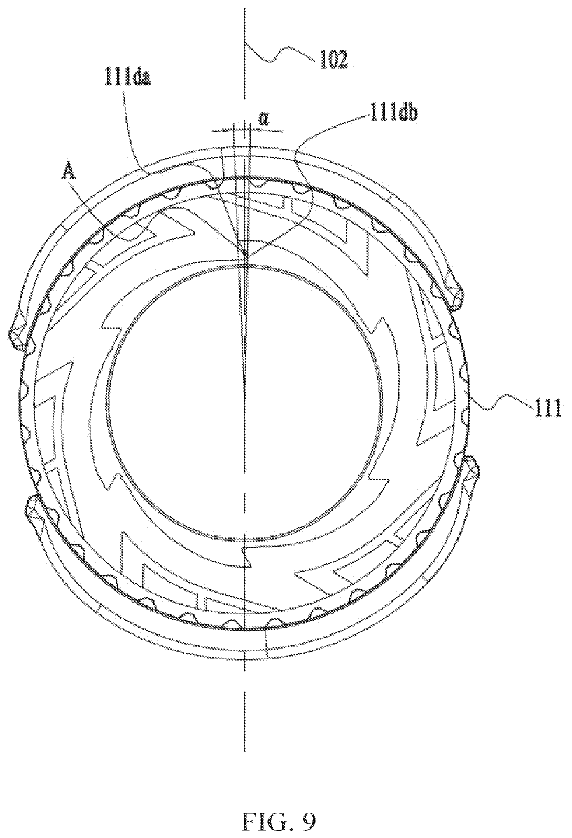

Exemplarily, as shown in FIGS. 8 to 9, the tooth surface of the first teeth 111f obliquely intersects the straight line 102 and forms a preset angle. The first teeth 111f incline toward the first rotation direction. In some examples, the angle between the tooth surface of the first teeth 111f and the straight line 102 is greater than 0° and less than or equal to 45°. During the grass trimming process of the string trimmer 100, the trimming head 11 always keeps rotating at a constant speed. When the transmission member 113a rotates with the spool 112 at the constant speed, there will be an interaction force F between the driving portion 113c and the mating surface 111d of the head housing 111. Exemplarily, the force F is distributed along a direction perpendicular to mating surface 111d. In this example, the mating surface 111d extends in a first plane 103, and the first plane 103 is substantially parallel to the rotation axis 101. There is a preset minimum distance L between the rotation axis 101 and the first plane 103, and the distance L is greater than zero. With this arrangement, the aforementioned interaction force F can be generated between the mating surface 111d and the driving portion 1113. When the lowest distance between the rotation axis and the first plane 103 is greater than 0 and less than or equal to 20 mm, the above-mentioned interaction force F will have better effect.

In addition, the mating surface 111d is not limited to the tooth surface which is smooth and continuous formed on the first teeth 111f in this example. The mating surface 111d can exist in any form as long as it can provide a force acting on the driving portion 113c. In fact, the mating surface 111d includes an effective surface capable of providing a reaction force with the driving portion 113c, and the effective surface has a projection line in a plane perpendicular to the rotation axis. The projection line includes a first extreme position 111da and a second extreme position 111db that can generate an interaction force with the driving portion 113c. Here, it is defined that the effective acting surface is located between the first extreme position 111da and the second extreme position 111db, and the part beyond the first extreme position 111da and the second extreme position 111db cannot produce a reaction force with the driving portion 113c. In fact, there may also be a section between the first extreme position 111da and the second extreme position 111db that cannot generate a reaction force with the driving portion 113c. The section between the extreme position 111db and the section where the reaction force can be generated between the driving portion 113c is defined as the effective action surface. In this example, a central angle α is formed between the first extreme position 111da and the second extreme position 111db and the axis of the rotation axis, and the center angle α is greater than 0° and less than or equal to 45°. Within the range of the central angle α, the reaction force can be effectively generated between the mating surface 111d and the driving portion 113c. When the aforementioned central angle α is greater than or equal to 3° and less than or equal to 40°, the effect of the reaction force generated between the mating surface 111d and the driving portion 113c is better.

However, during the rotation of the trimming head 11, due to the change in the length of the trimming line 15, the torque outputted by the trimming head 11 also changes accordingly. Exemplarily, the longer the trimming line 15 is, the greater the torque outputted by the trimming head 11 will be, and the greater the interaction force between the transmission member 113a and the head housing 111 will be. On the contrary, the shorter the trimming line 15 is, the smaller the torque outputted by the head 11 will be, and the smaller the interaction force between the transmission member 113a and the head housing 111 will be.

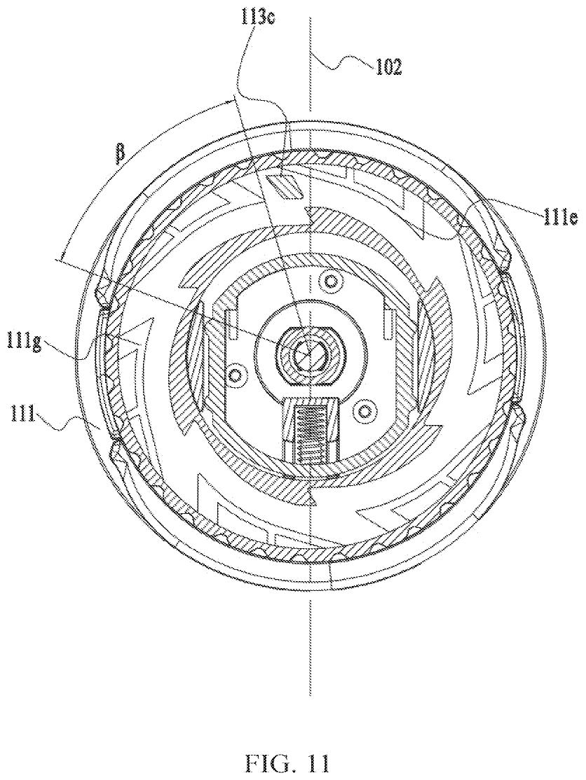

Here, any point on the mating surface 111d can be used for force analysis. As shown in FIG. 11, the interaction force F between the first teeth 111f of the head housing 111 and the driving portion 113c of the transmission member 113a is distributed along a direction of the tooth surface perpendicular to the mating surface 111d, which can be decomposed into a first component force in the direction of the straight line 102 and a second component force F1 in the direction of the straight line 102, wherein the direction of the second component force F1 is opposite to the direction of the centrifugal force F0. In addition, a friction is generated between the transmission member 113a and the spool 112 due to the centrifugal force F0, and the friction is actually generated when the transmission member 113a slides in the sliding rail formed by the limiting portion 112b and the receiving groove 112c. Since the sliding rail is distributed symmetrically with respect to a plane passing through the straight line 102 and the rotation axis 101 at the same time, that is, in the direction of a straight line perpendicular to the rotation axis 101, the transmission member 113a and the limiting portion 112b include at least two contact surfaces. Therefore, the friction force includes F2 and F3, and F2 and F3 form a resultant force F4 distributed along the direction of the straight line 102. In addition, the biasing force between the transmission member 113a and the biasing element 113b can be defined as F5, and exemplarily, F1, F4, F5 are all distributed along the direction of the straight line 102 and deviate from the centrifugal force F0. In this example, F0 is only related to the mass of the transmission member 113a, the angular velocity of the trimming head 11 and the radius of the spool 112. That is, when the aforementioned parameters are all fixed values, F0 is a constant. F5 is the biasing force between the transmission member 113a and the biasing element 113b. When the elastic coefficient of the biasing element 113b is determined, F5 is also a constant. Therefore, during the rotation of the cutting head 11, when the load of the trimming head 11 changes due to the change in the length of the trimming line 15, only F changes, that is, F1 changes. F4 is a sliding friction force between transmission member 113a and the spool 112. When the material and contacting area of the transmission member 113a and the spool 112 are determined, F4 changes synchronously with F1. Therefore, when the trimming line 15 is greater than a preset length, the torque of the trimming head 11 is relative large at this time, resulting in a large F1, so that F0<F1+F4+F5, that is, the centrifugal force at this time is less than the summation of F1, F4 and F5. The transmission member 113a cannot be separated from the first teeth 111f under the action of centrifugal force, and the entire trimming head 11 is in the first equilibrium state. When the trimming line 15 is less than a preset length, the torque of the trimming head 11 is smaller at this time, resulting in a smaller F1, so that F0>F1+F4+F5, that is, the centrifugal force at this time is greater than the summation of F1, F4 and F5. The transmission member 113a is separated from the first teeth 111f under the action of centrifugal force, and the entire trimming head 11 is in the second equilibrium state. At this time, the spool 112 can rotate relative to the head housing 111, and the trimming head 11 starts to feed the trimming line.

In one example, the angle between the tooth surface of the mating surface 111d and the direction of the straight line 102 is 18°. When the length of the effective portion of the trimming line 15 is greater than a preset value, the torque at the output end of the motor is 0.505 N·m. At this time, the mechanics calculation is carried out according to the principle of force reaction:

T=F*R (1)

Where T represents the torque at the output end of the motor, F represents the interaction force between the spool 112 and the transmission member 113a on a tooth surface perpendicular to the first teeth 111f, and R represents a force radius of an action point on the tooth surface.

It is deduced that when the length of the effective portion of the trimming line 15 is greater than the preset value, the force of the transmission member 113a is as follows:

F=T/R=0.505/37.5*1000=13.47N (2)

F1=F*sin 18=13.47*sin 18=4.16 N (3)

F4=F*k=13.47*0.25=3.37N (4)

F5=3N (5)

F0=mw\hat{ }2*r=0.0167*607.37*607.37*0.0014=8.62N. (6)

It can be concluded that when the length of the effective portion of the trimming line 15 is greater than the preset value, the relationship between the centrifugal force received by the transmission member 113a and other resultant forces is 8.62<4.16+3.37+3=10.53 and F0<F1+F4+F5.

Therefore, at this time, the centrifugal force received by the transmission member 113a is smaller than the resultant force which driving the transmission member 113a toward the driving portion 113c to engage with the first teeth 111f on the head housing 111, and the transmission member 113a keeps engaging with the head housing 111 when receiving the resultant force of all the forces.

When the effective portion of the trimming line 15 is worn and shortened by 40 mm, the torque at the output end of the motor is 0.265 N·m. At this time, it is deduced that when the length of the effective portion of the trimming line 15 is worn to less than the preset value, the force of the transmission member is as follows:

F=T/R=0.24/37.5*1000=7.07N (7)

F1=F*sin 18=7.07*sin 18=2.18 N (8)

F4=F*k=7.07*0.25=1.77N (9)

F5=3N (10)

F0=mw\hat{ }2*r=0.0167*607.37*607.37*0.0014=8.62N (11)

It can be concluded that when the length of the effective portion of the trimming line 15 is less than the preset value, the relationship between the centrifugal force received by the transmission member 113a and other resultant forces is 8.62>2.18+1.77+3=6.95 and F0>F1+F4+F5.

Therefore, at this time, the centrifugal force received by the transmission member 113a is greater than the resultant force of the engagement between the driving portion 113c which drives the transmission member 113a and the first teeth 111f on the head housing 111. Therefore, the transmission member 113a is under the resultant force of all the forces received and moves along the direction of the straight line to separate from the head housing 111, so that the transmission member 113a allows the head housing 111 and the spool 112 to rotate relative to each other at this time, and then the trimming line 15 can be released at this time.

The mechanical calculation process shown above is only to facilitate the understanding of the force relationship between the spool 112, the head housing 111 and the transmission member 113a when the trimming head 11 is in the first equilibrium state and the string trimmer 11 rotates is at a constant speed. During use, the above data will have a preset deviation, which does not limit the protection scope of the present disclosure in other examples.

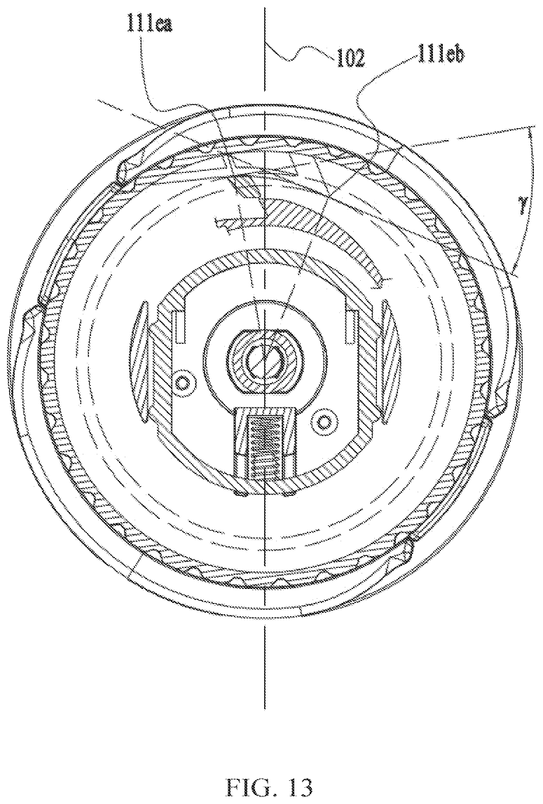

As shown in FIGS. 12 to 13, when the trimming head 11 is in the second equilibrium state, the transmission member 113a is not constrained by the first teeth 111f and the second teeth 111g, and can continue to follow the direction of the straight line 102 under the action of centrifugal force and move toward the second teeth 111g. When the driving portion 113c of the transmission member 113a moves to the second teeth 111g of the head housing 111, the driving portion 113c starts to contact the return surface 111e. During the relative rotation of the return surface 111e between the head housing 111 and the spool 112, the transmission member 113a can be pushed to move along the straight line 102 toward the first teeth 111f, and finally engaged with the first teeth 111f, so as to complete a line-feeding and enter the next autonomously identification. In this example, the second teeth 111d are not uniformly distributed in the circumferential direction around the rotation axis 101, and they have gradual arc on the tooth surfaces facing the direction of the rotation axis 101. The protrusions 111e have a substantially continuous smooth surface to continuously push the transmission member 113a back to the first teeth 111f and engage with the first teeth 111f. In fact, as an implementation, in a plane perpendicular to the rotation axis 101, the central angle β formed by the line connecting a tooth tip or a tooth bottom of the second teeth 111g together with the rotation axis 101 respectively is greater than or equal to 300 and less than or equal to 50°. The tooth surface of the second teeth 111g close to the rotation axis 101 also includes a first section 111i and a second section 111j. Wherein, when the driving portion 113c of the transmission member 113a is located in the area where the first section 111i is located, the first section 111i does not generate the driving force on the transmission member 113a. When the transmission member 113a is separated from the first teeth 111f, since the head housing 111 is not driven at this time, the head housing 111 is in a stalled state, so that it rotates relative to the spool 112. At this time, the driving portion 113c quickly moves to the second section 111j and contacts the second section 111j. During this process, the trimming line 15 is continuously released, and the return surface 111e continuously pushes the driving portion 113c to reset back to the first teeth 111f Exemplarily, in order for that the return surface 111e can push the driving portion 113c to reset to the first teeth, the return surface 11e has a projection line in a plane perpendicular to the rotation axis 101, and the return surface 111e is configured to include a first extreme position 111ea and a second extreme position 111eb within the area of the projection line, and the first extreme position 111ea and the second extreme position 111eb can push the transmission member 113a to return to the mating surface. The return surface 111e is also configured to include a first circumference centered on the axis of the rotation axis 101 and passing through the first extreme position 111ea, and a second circumference centered on the axis of the rotation axis 101 and passing through the second extreme position 111eb. An angle γ formed by the tangent line of the first circumference at the first extreme position 111ea and the tangent line of the second circumference at the second extreme position 111eb is greater than or equal to 15°. In fact, when the driving portion 113c is in contact with the return surface 111e, when the driving portion 113c is in the first extreme position 111ea, at this time, the head housing 111 has just entered the stall state, and there is still a small speed difference between the driving portion 113c and the spool 112. When the driving portion 113c is in contact with the return surface 111e, the return surface 111e has a first interaction force to push the driving portion 113c to reset back to original place. As the relative rotation between the head housing 111 and the spool 112 continues, the driving portion 113c and the direct contact of the return surface 11e is closer. At the same time, the relative speed between the head housing 111 and the spool 112 gradually increases, and the force between the return surface 111e and the driving portion 113c gradually increases until the driving portion 113c is in the second position. At the second extreme position 111eb, the return surface 111e pushes the transmission member 113a to completely recover. At this time, the return surface 111e has a second interaction force that pushes the driving portion 113c to recover, wherein the first interaction force is smaller than or equal to the second interaction force. Here, in order to enable the transmission member to be pushed and reset to the first teeth, the aforementioned angle γ is configured to be greater than or equal to 15°, so that the return surface has an effective length that can push the transmission member to the first position. Exemplarily, when the angle γ is configured to be greater than or equal to 20°, the return surface 11e can be more reliably to push the transmission member 113a to the first position, and at this time, the line-feeding effect of the trimming head 11 is better. In one example, if the return surface 11e pushes the transmission member 113a to the first position quickly, the trimming line 15 may not be released in time and effectively.

In fact, the second section and the tooth surface of the first teeth 111f away from the rotation axis 101 forms a guiding channel 111h. The guiding channel can guide the driving portion 113c to reset to the first position, that is, the position of the engagement of the driving portion 113c and the first teeth 111f. Exemplarily, due to the existence of the return surface 111e and the continuous extension of the return surface 111e, the driving portion 1113c will never engage with the second teeth 111g. Thus, it is ensured that the length in every release cycle of the trimming line 15 is limited to a small range, so as to avoid the excessive release of the trimming line 15 which can lead to increase of the load of the motor 122 or avoid the trimming line 15 from breaking the guard 16 due to the excessively long length of the trimming line 15 being released.

In fact, when turning on the tool, when the trimming head 11 accelerates from a static state to a constant speed state, if the trimming line 15 is greater than a preset length, the trimming line 15 will not be released due to the speed change; if the trimming line 15 is less than a preset length, the trimming line 15 will be released to a length greater than the preset length as the speed changes. In one example, the release of the trimming line 15 is not related to the speed change. It is only because the trimming line 15 is relatively short and the torque at the output end of the motor is relatively small, so that the trimming line 15 is released.

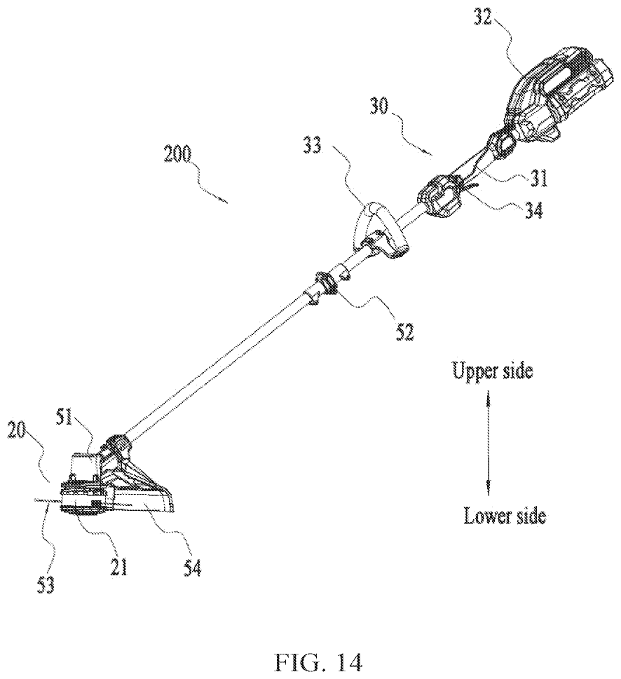

A string trimmer 200 shown in FIG. 14 includes a string trimmer head 20, a drive device 51, an operating device 30, and a connecting device 52.

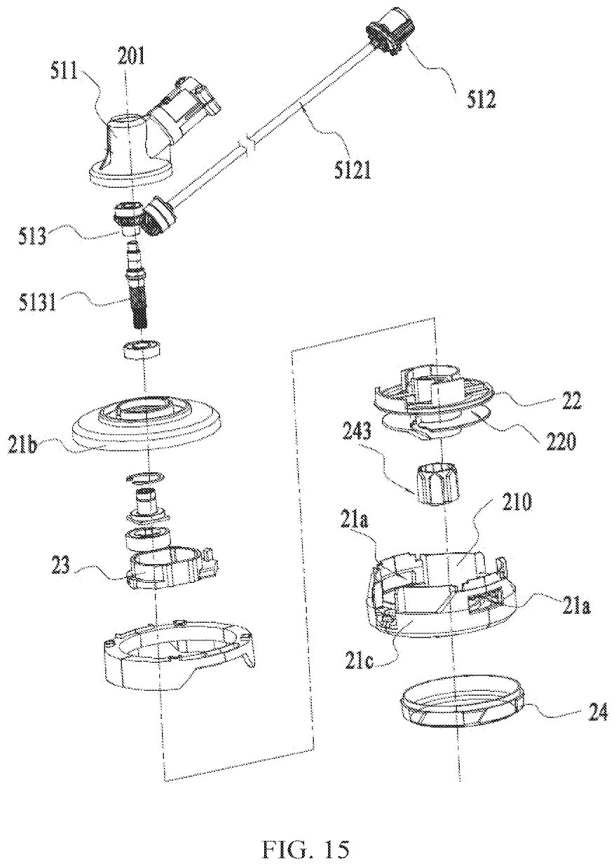

As shown in FIG. 14, the string trimmer head 20 is used for mounting a string trimmer line 53 to implement a trimming function, where the string trimmer line 53 is used for trimming, and the string trimmer head 20 is used for driving the string trimmer line 53 to rotate at a high speed to cut vegetation such as grass and trees. As shown in FIGS. 14 and 15, the drive device 51 is used for providing power for the string trimmer head 20 to rotate, the drive device 51 includes a first housing 511 and a motor 512, the first housing 511 is used for connecting the operating device 30, and the motor 512 is used for driving the string trimmer head 20 to rotate about a central axis 201 of a head housing 21.

As shown in FIGS. 14 to 16, the operating device 30 includes a handle 31, a second housing 32, an auxiliary handle 33, and a main switch 34. The handle 31 and the auxiliary handle 33 are held by hands of a user separately so that the string trimmer 200 can be operated more stably. The main switch 34 may be disposed on the handle 31, and the user can directly operate the main switch 34 when holding the handle 31 to control the string trimmer 200 to trim grass. The second housing 32 is used for forming a coupling portion for coupling a power supply device. For example, the coupling portion can couple a battery pack to supply power to the string trimmer 200. In some examples, the handle 31 and the second housing 32 are formed separately. It is to be understood that in some other examples, the handle 31 may be integrally formed with the second housing 32. In some examples, the motor 512 is disposed in the first housing 511. In some other examples, the motor 512 may be disposed in the second housing 32, the drive device 51 also includes a transmission device 513, the transmission device 513 is disposed in the first housing 511, and the motor 512 drives, through the transmission device 513, the string trimmer head 20 to rotate about the central axis 201 of the head housing 21. The connecting device 52 includes a connecting rod for connecting the first housing 511 to the second housing 32. The auxiliary handle 33 is mounted to the connecting rod, and the auxiliary handle 33 is disposed between the first housing 511 and the second housing 32. The string trimmer 200 further includes a shield 54 at least partially distributed around the string trimmer head 20. When the string trimmer head 20 is trimming grass, the shield 54 can prevent grass crumbs from flying towards where the user stands.

To facilitate the description of technical solutions of the present application, an upper side and a lower side are defined, as shown in FIG. 14, where the drive device 51 is disposed on the upper side of the string trimmer head 20, and the string trimmer head 20 is disposed on the lower side of the drive device 51.

As shown in FIGS. 15 to 17, the string trimmer head 20 includes the head housing 21, a spool 22, an automatic line release device 23, and an operating member 24. The head housing 21 is formed with an accommodation space 210 around the central axis 201 of the head housing 21, where the accommodation space 210 can accommodate at least part of the spool 22. The head housing 21 may include an upper housing 21b and a lower housing 21c, where the upper housing 21b and the lower housing 21c together surround the accommodation space 210. Aside of the head housing 21 where the accommodation space 210 is formed is an inner side of the head housing 21, and the other side of the head housing 21 opposite to the inner side is an outer side. The spool 22 is disposed in the accommodation space 210, that is to say, the spool 22 is disposed on the inner side of the head housing 21. The spool 22 may include a winding groove 220 for winding the string trimmer line 53. The automatic line release device 23 is used for making the string trimmer head 20 release the string trimmer line 53 and configured to enable the spool 22 and the head housing 21 to generate a first relative rotation so that the spool 22 releases the string trimmer line 53. The operating member 24 is configured to be operable by the user to drive the spool 22 and the head housing 21 to generate a second relative rotation so that the string trimmer line 53 is wound into the winding groove 220. The operating member 24 may be connected to the spool 22 and at least partially extend to the outer side of the head housing 21 to be operated by the user.

The string trimmer 200 has an automatic winding mode, a manual winding mode, and a trimming mode. It may also be considered that the string trimmer head 20 has the automatic winding mode, the manual winding mode, and the trimming mode. When the user starts the motor 512 by operating the switch 34, the motor 512 can drive the spool 22 together with the head housing 21 to rotate about the central axis 201 of the head housing 21 along a first direction so that the string trimmer 200 is in the trimming mode. When the string trimmer head 20 is in the automatic winding mode, the motor 512 may drive the spool 22 and the head housing 21 to generate the second relative rotation, that is, the spool 22 rotates about the central axis 201 of the head housing 21 and relative to the head housing 21 along a second direction so that the string trimmer line 53 is automatically wound onto the spool 22. When the string trimmer head 20 is in the manual winding mode, the user may rotate the operating member 24 to drive the spool 22 and the head housing 21 to generate the second relative rotation, that is, the spool 22 rotates about the central axis 201 of the head housing 21 and relative to the head housing 21 along the second direction so that the string trimmer line 53 can also be wound onto the spool 22. The first direction is opposite to the second direction. In some examples, when the string trimmer head 20 is viewed from the motor 512, the second direction may be considered as a counterclockwise direction, and correspondingly, the first direction may be considered as a clockwise direction, which is not a limitation. It is to be understood that in other examples, a motor shaft 5121 may be connected to the head housing 21 to drive the head housing 21 to rotate. In this manner, when the string trimmer head 20 is in the automatic winding mode, the motor 512 drives the head housing 21 to rotate so that the spool 22 rotates relative to the head housing 21 along the second direction, so as to automatically wind the string trimmer line 53 onto the spool 22. Similarly, the operating member 24 may be connected to the head housing 21. When the string trimmer head 20 is in the manual winding mode, the user operates the operating member 24 to drive the head housing 21 to rotate so that the spool 22 rotates relative to the head housing 21 along the second direction, so as to wind the string trimmer line 53 onto the spool 22.

The string trimmer head 20 may not only transmit power to the spool 22 from the side of a power shaft 5131 to automatically wind the string trimmer line 53 but also transmit power to the spool 22 from the side of the operating member 24 to wind the string trimmer line 53 around the spool 22 so that the user may either trigger the operating device 30 to automatically wind the string trimmer line 53 or rotate the operating member 24 to manually wind the string trimmer line 53, thereby achieving the string trimmer 200 integrating manual winding and automatic winding. In one aspect, when the user rotates the operating member 24 to wind the string trimmer line 53, the user may feel fatigued. At this time, the user may operate the operating device 30 to automatically wind the string trimmer line 53 around the spool 22, thereby facilitating the operation of the user and improving working efficiency. Additionally, when the automatic winding mode of the string trimmer 200 fails, the user may rotate the operating member 24 to manually wind the string trimmer line 53 around the spool 22, thereby improving the reliability of the string trimmer 200.

The head housing 21 is further formed with external threading holes 21a for the string trimmer line 53 to extend to the outer side of the head housing 21. Two external threading holes 21a are provided. When the user needs to replenish the string trimmer line 53, the user does not need to open the head housing 21 and may thread the string trimmer line 53 through an external threading hole 21a into the accommodation space 210 so that the string trimmer line 53 directly extends into the head housing 21 and is wound around the spool 22 through the relative rotation between the spool 22 and the head housing 21. Such a string trimmer head 20 is generally referred to as an external plug-in winding string trimmer head.

A part of the string trimmer line 53 extending out of the head housing 21 through the external threading holes 21a is defined as an effective part of the string trimmer line 53, and the effective part of the string trimmer line 53 cuts weeds by rotating at a high speed. To trim weeds within a certain range, the length of the effective part of the string trimmer line 53 needs to reach a preset value, that is, the length of the effective part of the string trimmer line 53 is necessarily greater than or equal to the preset value. When the length of the effective part of the string trimmer line 53 is less than the preset value, the trimming efficiency of the string trimmer line 53 may decrease since the effective part of the string trimmer line 53 is relatively short. To keep the length of the effective part of the string trimmer line 53 always greater than or equal to the preset value, the string trimmer 200 in this example may implement the following: when the length of the effective part of the string trimmer line 53 is less than the preset value, the automatic line release device 23 controls the string trimmer line 53 to be automatically released to a length greater than or equal to the preset value. It is to be explained here that to prevent the string trimmer line 53 from extending too much and interfering with the shield 54, the effective part of the string trimmer line 53 is actually less than or equal to a limit value. Within this limit range, the string trimmer line 53 can effectively trim grass and maintain relatively high trimming efficiency in one aspect; in another aspect, the string trimmer line 53 is unlikely to interfere with the shield 54 and thus can perform continuous trimming.

The automatic line release device 23 is used for controlling a line release of the string trimmer head 20. The automatic line release device 23 has a first equilibrium state for preventing the line release of the string trimmer head 20, and the string trimmer head 20 is in a working state. The automatic line release device 23 also has a second equilibrium state for allowing the line release of the string trimmer head 20, and the string trimmer head 20 is in an autonomous line release state. In some examples, the automatic line release device 23 can autonomously identify an effective length of the string trimmer line 53 and automatically adjust the string trimmer head 20 according to the length of the effective part of the string trimmer line 53 to enter the first equilibrium state or the second equilibrium state, that is, adjust the string trimmer head 20 to automatically enter the working state or the autonomous line release state. The automatic line release device 23 may autonomously identify and adjust the working state of the string trimmer head 20 based on the automatic line release device 23 itself or by receiving an externally inputted indication signal of line release or trimming. The indication signal here includes a signal for mode switching of the automatic line release device 23 due to an external force, an electrical signal, a magnetic force, or another force generated by the outside on the string trimmer head 20. Among some common indication signals, the indication signal generally includes knocking a housing of the string trimmer head 20 to cause a speed difference between the spool 22 and the head housing 21 and thus implement the line release, regulating a speed through the switch to cause a speed difference between the spool 22 and the head housing 21 and thus implement the line release, or sensing a current change of the motor through a sensor to cause a speed difference between the spool 22 and the head housing 21 and thus implement the line release.

In some examples, the string trimmer head 20 has a constant rotational speed and does not require a rotational speed of the motor 512 to be adjusted for a change of a rotational speed of the spool 22 to obtain the speed difference between the head housing 21 and the spool 22 and perform the line release.

In some specific examples, when the automatic line release device 23 is in the first equilibrium state, the spool 22 and the head housing 21 are relatively stationary. In this manner, the spool 22 and the head housing 21 are driven by the power shaft 5131 to rotate synchronously so that the length of the effective part of the string trimmer line 53, which is wound around the spool 22, extending out of the head housing 21 does not change, that is, the string trimmer line 53 cannot be released and the string trimmer head 20 is in a normal working state. When the automatic line release device 23 is in the second equilibrium state, the spool 22 and the head housing 21 move relatively, and the string trimmer line 53 is thrown out relative to the spool 22 under the action of a centrifugal force of the string trimmer line 53 so that the string trimmer line 53 is released and the length of the effective part of the string trimmer line 53 increases.

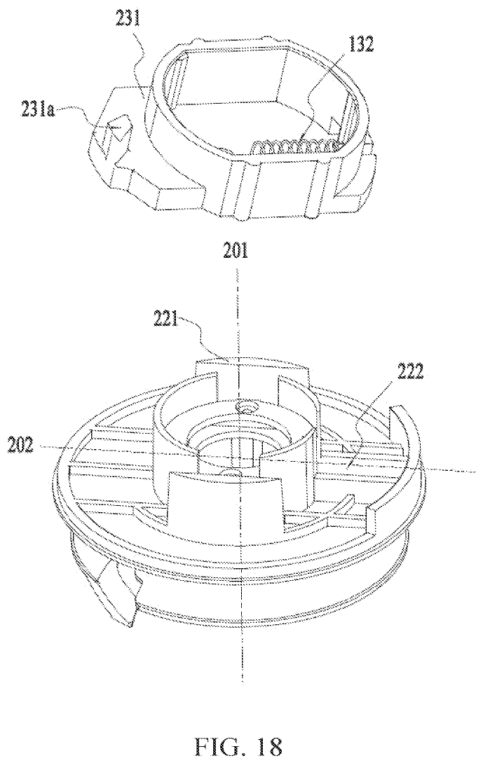

As shown in FIGS. 18 to 20, in some specific examples, the automatic line release device 23 includes a transmission member 231 capable of moving freely between the spool 22 and the head housing 21. When the automatic line release device 23 is in the first equilibrium state, the transmission member 231 rotates synchronously with the spool 22, the transmission member 231 is at a first position, the transmission member 231 mates with the head housing 21 to drive the head housing 21 to rotate synchronously with the spool 22, and the motor has a first rotational speed. When the automatic line release device 23 is in the second equilibrium state, the transmission member 231 rotates with the spool 22 and is disengaged from the head housing 21, the transmission member 231 is at a second position, the spool 22 and the head housing 21 can move relatively, and the motor 512 has a second rotational speed. As an implementation, when the transmission member 231 is at the first position or the second position, the ratio of an absolute value of a difference between the first rotational speed and the second rotational speed of the motor 512 to the first rotational speed is greater than or equal to 0 and less than or equal to 0.15. As an example, when the transmission member 231 is at the first position or the second position, the ratio of the absolute value of the difference between the first rotational speed and the second rotational speed of the motor 512 to the first rotational speed is greater than or equal to 0 and less than or equal to 0.1. In fact, in a relatively good state, when the transmission member 231 is at the first position or the second position, the ratio of the absolute value of the difference between the first rotational speed and the second rotational speed of the motor 512 to the first rotational speed is greater than or equal to 0 and less than or equal to 0.05, and the ratio of the absolute value of the difference between the first rotational speed and the second rotational speed of the motor 512 to the first rotational speed approaches 0 infinitely. With such a design, the string trimmer head 20 has no change in speed and can achieve an autonomous line release, that is, a fully automatic line release in a true sense. It is to be understood that when the transmission member 231 of the string trimmer head 20 is displaced or the string trimmer line 53 is released to a preset length due to wear or in an autonomous line release process, a certain force is generated so that the rotational speed of the string trimmer head 20 has a certain change due to the effects of factors such as a load of the string trimmer line 53 and a relative motion between internal parts of the string trimmer head 20 on the string trimmer head 20. Thus, the string trimmer head 20 cannot always maintain an absolutely constant speed in a theoretical sense and has a second speed different from a first speed. Here, within the preceding allowable error range, it is considered that the string trimmer head 20 still rotates at the constant speed as described above when changing from the first speed to the second speed, and the string trimmer head 20 switches between the autonomous line release state and the working state without depending on the preceding change in speed.

Specifically, in a direction of a straight line 202 substantially perpendicular to the central axis 201 of the head housing 21 or obliquely intersecting the central axis 201 of the head housing 21, the transmission member 231 is disposed between the spool 22 and the head housing 21 along the direction of the straight line 202. The transmission member 231 is provided with a transmission hole through which the transmission member 231 is sleeved on the spool 22 and can rotate synchronously with the spool 22. Thus, when the motor 512 drives the spool 22 to rotate, the transmission member 231 can rotate synchronously with the spool 22.

The spool 22 is further formed with or connected to a limiting portion 221 capable of limiting a displacement of the transmission member 231 in a circumferential direction around the central axis 201 of the head housing 21. Specifically, the limiting portion 221 is a pair of protrusions disposed symmetrically about a plane of symmetry passing through the straight line 202, and the transmission member 231 can be limited within the range of the limiting portion 221 when sleeved on the spool 22 along the direction of the central axis 201 of the head housing 21 and can only displace radially along the direction of the straight line 202 perpendicular to the central axis 201 of the head housing 21. The transmission member 231 is asymmetric in mass distribution relative to a plane of symmetry passing through the central axis 201 of the head housing 21. Further, the centroid of the transmission member 231 deviates from the central axis 201 of the head housing 21 so that when the string trimmer head 20 is driven by the motor 512 to rotate, the transmission member 231 is subjected to a centrifugal force to have a tendency to move from the first position to the second position. When rotating about the axis of rotation 201, the head housing 21 applies resistance to the transmission member 231, which resists the centrifugal force to prevent the transmission member from moving from the first position to the second position. A biasing element 232 is further provided between the transmission member 231 and the spool 22, where the biasing element 232 may specifically be a coil spring.

More specifically, an accommodation groove 222 extends on the spool 22, the coil spring is at least partially disposed in the accommodation groove 222, an end of the coil spring abuts against the bottom of the accommodation groove 222, and the other end of the coil spring abuts against the transmission member 231. The center of gravity of the transmission member 231 and the coil spring are disposed on two sides of the central axis 201 of the head housing 21. Additionally, the limiting portion 221 mates with the accommodation groove 222 to form a slide rail for the transmission member 231 to slide, that is, the transmission member 231 is slidably connected to the spool 22. When the transmission member 231 rotates with the spool 22, the transmission member 231 generates the centrifugal force while the transmission member 231 is subjected to a biasing force of the biasing element 232, where the biasing force and the centrifugal force have opposite directions. The directions of the centrifugal force and the biasing force may further be the direction of the straight line 202, and the transmission member 231 may be slidably connected to the spool 22 along the direction of the straight line 202. The center of gravity of the transmission member 231 and the biasing element 232 are disposed on two sides of a plane passing through the central axis 201 of the head housing 21 and perpendicular to the straight line 202, separately. It is to be understood that when moving relative to the spool 22 along the direction of the straight line 202, the transmission member 231 is also subjected to a frictional force between the transmission member 231 and the spool 22, where the frictional force can effectively prevent the biasing element 232 from overcoming the centrifugal force and prevent the automatic line release device 23 from being too flexible and releasing the string trimmer line by mistake.

In some examples, the head housing 21 forms the preceding accommodation space 210 around the central axis 201 of the head housing 21, the spool 22 is at least partially disposed in the accommodation space 210 formed by the head housing 21, and the transmission member 231 is at least partially disposed in the accommodation space 210. Specifically, the head housing 21 includes the upper housing 21b, the upper housing 21b does not close the accommodation space 210, and the power shaft 5131 penetrates through the upper housing 21b and extends into the accommodation space 210. A mating portion 211 that can be driven by the transmission member 231 is formed on the lower side of the upper housing 21b, and the transmission member 231 is formed with a drive portion 231a mating with the mating portion 211. When the drive portion 231a mates with the mating portion 211, a force can be transmitted between the transmission member 231 and the head housing 21. Specifically, the mating portion 211 includes a mating surface 211a and a reset surface 211b. The mating surface 211a is used for being in contact with the drive portion 231a to apply a reaction force to the drive portion 231a; and the reset surface 211b is used for being in contact with the drive portion 231a to apply a force to the drive portion 231a. When the drive portion 231a mates with the mating surface 211a, the string trimmer head 20 is in the working state; and when the drive portion 231a mates with the reset surface 211b, the string trimmer head 20 is in the autonomous line release state.

Specifically, the mating surface 211a extends along a first straight line 203, where the first straight line 203 does not pass through the central axis 201. In this manner, a force F perpendicular to the first straight line 203 is generated between the mating portion 211 and the drive portion 231a, and the magnitude of the force F is affected by the change of the effective length of the string trimmer line 53. When the effective length of the string trimmer line 53 is greater than the preset value, the string trimmer line 53 is subjected to a relatively large centrifugal force, and the relatively large force is transmitted to the drive portion 231a through the head housing 21 so that the drive portion 231a is subjected to a relatively large force F. When the effective length of the string trimmer line 53 is less than the preset value, the string trimmer line 53 is subjected to a relatively small centrifugal force, and the relatively small centrifugal force makes the drive portion 231a subjected to a smaller force F. The transmission member 231 is subjected to a centrifugal force of the transmission member itself, the frictional force, the biasing force, and the force F. When the effective length of the string trimmer line 53 is greater than the preset value, the centrifugal force of the transmission member 231, the frictional force, the biasing force, and the force F are in a balanced state, that is, a resultant force of the four forces is basically 0 so that the transmission member 231 remains at the first position, and the string trimmer 200 is in the trimming state. When the effective length of the string trimmer line 53 is less than the preset value, the centrifugal force of the transmission member 231, the frictional force, the biasing force, and the force F are out of the balanced state, that is, the transmission member 231 moves away from the first position under the action of the force, and the string trimmer 200 switches from the trimming state to the autonomous line release state to implement an automatic line release. For a detailed description of the implementation principle of the automatic line release device 23, reference may be made to U.S. patent application Ser. No. 17/551,225 filed Dec. 15, 2021, the disclosure of which is incorporated herein by reference in its entirety.

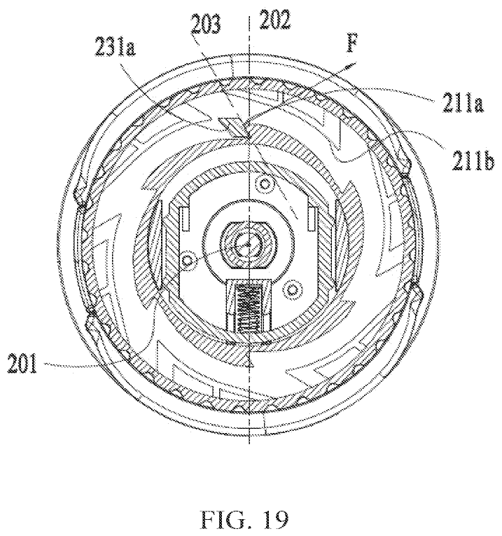

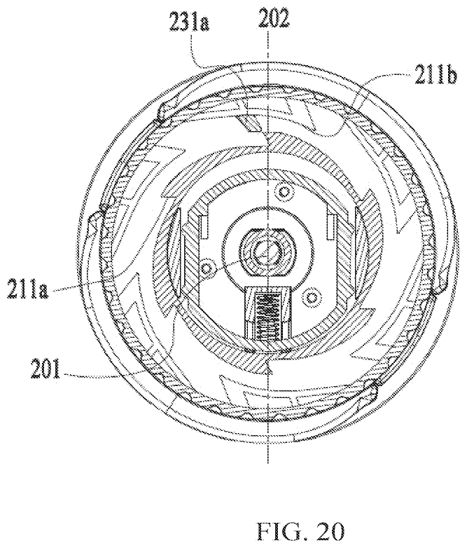

As shown in FIGS. 19 and 20, the upper housing 21b is formed with an inner ring and an outer ring, both of which are formed around the central axis 201 of the head housing 21, the inner ring is formed with first teeth which are specifically external teeth formed on the inner ring and protruding towards the outer ring, and the outer ring is formed with second teeth which are specifically internal teeth formed on the outer ring and protruding towards the inner ring. A first tooth constitutes or forms the preceding mating surface 211a, and a second tooth constitutes or forms the precede reset surface 211b. Multiple first teeth are provided, and multiple second teeth are also provided. In the circumferential direction around the central axis 201 of the head housing 21, the first tooth and the second tooth are staggered from each other, that is to say, the first tooth and the second tooth are not simultaneously arranged in a direction of a diameter perpendicular to the central axis 201 of the head housing 21. Specifically, the drive portion 231a on the transmission member 231 may be configured to be an engagement tooth mating with the first tooth and the second tooth. In some examples, the drive portion 231a and the biasing element 232 are disposed on two sides of the transmission member 231 separately, that is to say, the drive portion 231a and the centroid of the transmission member 231 are disposed on the same side of the central axis 201 of the head housing 21.

As shown in FIG. 19, when the drive portion 231a of the transmission member 231 meshes with the first tooth or the second tooth and the power shaft 5131 rotates along the first direction, the transmission member 231 makes the head housing 21 stationary relative to the spool 22, that is to say, no relative motion is generated between the spool 22 and the head housing 21. It may be considered that the automatic line release device 23 is in the first equilibrium state, and the string trimmer 200 is in the working state of normal trimming. As shown in FIG. 20, when the drive portion 231a of the transmission member 231 is disengaged from the first tooth and the second tooth, the whole constituted by the transmission member 231 and the spool 22 can move relative to the head housing 21. In some examples, the direction in which the spool 22 moves relative to the head housing 21 is consistent with a trimming direction of the string trimmer 200. In this case, the spool 22 can move relative to the head housing 21. It may be considered that the automatic line release device 23 is in the second equilibrium state, that is, the string trimmer head 20 is in the autonomous line release state.

In some examples, a damping device is further provided, where the damping device enables the spool 22 and the head housing 21 to generate a relative rotation. Specifically, the damping device may be configured to be a limiting pin (not shown) for limiting a rotation of the head housing 21 or the spool 22 and can be inserted into a limiting hole reserved on the head housing 21 or the spool 22 to limit the rotation of the head housing 21 or the spool 22. As another implementation, the damping device may be configured to be a friction member (not shown) which can be in contact with the spool 22 or the head housing 21 so that the head housing 21 and the spool 22 move relatively due to a speed difference. As another implementation, the damping device may be configured to include a one-way bearing and a rotary support; where the one-way bearing enables two parts or portions connected to the one-way bearing to rotate relatively in only one direction of rotation and not to rotate relatively in the other direction of rotation. The rotary support is rotatably connected to a portion of the string trimmer head 20 and supports a rotation of the portion. The rotary support may be the first housing 511 that accommodates the motor 512 in the string trimmer 200 or another component fixedly connected to the first housing 511, such as the shield 54. More specifically, the one-way bearing is disposed between the rotary support and the head housing 21 so that they are rotatably connected in one direction, that is, when the rotary support is used for reference, the head housing 21 can rotate in one direction of rotation and cannot rotate in the other direction of rotation. The power shaft 5131 is non-rotatably connected to the spool 22 so that the spool 22 can rotate relative to the rotary support in two directions, that is, when the rotary support is used for reference, the spool 22 can rotate forwardly and reversely.

Based on the preceding hardware, when the motor 512 rotates forwardly, the power shaft 5131 drives the spool 22 to rotate forwardly. At this time, the transmission member on the spool 22 implements torque transmission by meshing with the first tooth, and the one-way bearing enables the head housing 21 to rotate forwardly relative to the rotary support (that is, relative to the whole string trimmer 200). At this time, the spool 22 and the head housing 21 rotate synchronously, and the string trimmer 200 may perform a cutting mode. When the motor 512 rotates reversely, the power shaft 5131 drives the spool 22 to rotate reversely, the head housing 21 is prevented from rotating reversely by the one-way bearing so that the spool 22 and the head housing 21 move relatively, and the drive portion 231a on the transmission member is disengaged from the first tooth due to the reverse rotation of the motor 512 so that the string trimmer 200 may perform an autonomous winding mode.

In a rotation process of the string trimmer head 20, the torque outputted by the string trimmer head 20 changes with the length of the string trimmer line 53. It is to be understood that the longer the string trimmer line 53, the greater the torque outputted by the string trimmer head 20 and the greater the interaction force between the transmission member 231 and the head housing 21; conversely, the shorter the string trimmer line 53, the smaller the torque outputted by the string trimmer head 20 and the smaller the interaction force between the transmission member 231 and the head housing 21.

Therefore, when the string trimmer line 53 is longer than a preset length, the torque of the string trimmer head 20 is relatively large, the transmission member 231 cannot be disengaged from the first tooth under the action of the centrifugal force, and the whole string trimmer head 20 is in the first equilibrium state. When the string trimmer line 53 is shorter than the preset length, the torque of the string trimmer head 20 is relatively small, the transmission member 231 is disengaged from the first tooth under the action of the centrifugal force, and the whole string trimmer head 20 is in the second equilibrium state. At this time, the spool 22 can rotate relative to the head housing 21, and the string trimmer head 20 starts the line release.

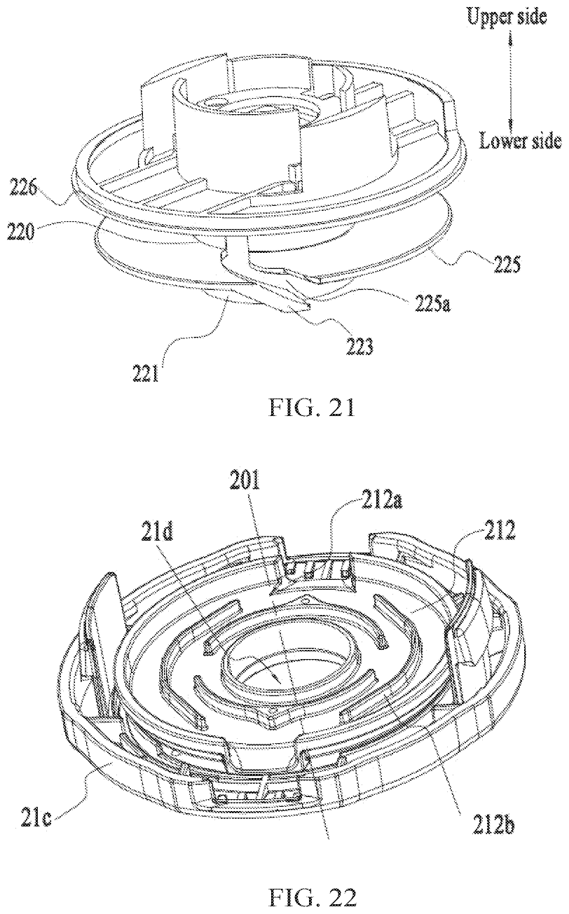

To be convenient for the user to quickly thread the string trimmer line 53 into the string trimmer head 20 and wind the string trimmer line 53 onto the spool 22 without disassembling the string trimmer head 20, as shown in FIGS. 21 to 24, a guide assembly is provided in the present application to guide the string trimmer line 53 to be wound onto the spool 22. The guide assembly includes a first guide structure 212 and a second guide structure 223. The first guide structure 212 facilitates the rapid threading of the string trimmer line 53 through the string trimmer head 20 by the user, and the second guide structure 223 guides the string trimmer line 53 to be wound onto the spool 22.

In some examples, the first guide structure 212 is disposed on an inner side of the lower housing 21c, and the second guide structure 223 is disposed on the spool 22. In an example, the first guide structure 212 and the second guide structure 223 are disposed on the lower side of the spool 22, and the automatic line release device 23 is disposed on the upper side of the spool. When the spool 22 is mounted inside the string trimmer head 20, the user may directly thread the string trimmer line 53 into the head housing 21 through one external threading hole 21a of the head housing 21 and out through the other external threading hole 21a. At this time, the string trimmer line 53 penetrates through the string trimmer head 20. Then, the spool 22 is rotated, the second guide structure 223 on the spool 22 guides the string trimmer line 53 into the winding groove 220 of the spool 22, the spool 22 continues to be rotated, and finally the string trimmer line 53 is all wound onto the spool 22, thereby achieving the storage of the string trimmer line 53.

As shown in FIG. 21, the spool 22 includes a body portion 224 and a stopper portion formed around the body portion 224. The stopper portion includes a first stopper portion 225 and a second stopper portion 226. The winding groove 220 is formed between the first stopper portion 225 and the second stopper portion 226. The stopper portion is configured to prevent the string trimmer line 53 from being out of the winding groove 220 along the direction of the central axis 201 of the head housing 21. In a plane perpendicular to the direction of the central axis 201 of the head housing 21, projections of the first stopper portion 225 and the second stopper portion 226 substantially coincide with each other and form a circular ring around the body portion 224.

The first stopper portion 225 is formed with the second guide structure 223 for guiding the string trimmer line 53 to be wound into the winding groove 220. In an example, the first stopper portion 225 is formed with two openings 225a symmetrical about the central axis 201 of the head housing 21, where each opening 225a is basically polygonal and communicates with the winding groove 220, and a fulcrum portion for guiding the string trimmer line 53 to be wound into the winding groove 220 is formed at the connection between the winding groove 220 and the opening 225a. The fulcrum portion is configured to apply a reverse force to the string trimmer line 53 to avoid a winding failure due to that the direction of a force is basically the same as the direction of the string trimmer line 53 when the user performs winding. The second guide structure 223 is disposed on the first stopper portion 225 and at the opening 225a. A structure formed at the opening 225 and protruding from a plane of the first stopper portion 225 and away from the first stopper portion 225 is the second guide structure 223. The second guide structure 223 is a protrusion upturned from the stopper portion and has a guide surface. The guide surface is smooth, continuous, and integrally formed with the first stopper portion 225. Alternatively, on the premise that the strength of the spool 22 is insufficient, the second guide structure 223 may be an independent element that satisfies a strength requirement and is fixedly connected to the first stopper portion 225. Additionally, to prevent the string trimmer line 53 from slipping out from an upper end of the second guide structure 223, a gap between the second guide structure 223 and the head housing 21 is configured to be less than the diameter of the string trimmer line 53. In this manner, the string trimmer line 53 can slide into the accommodation groove 220 only through the opening 225a. In an example, two second guide structures 223 are provided, and the two second guide structures 223 are disposed at the two openings 225a of the first stopper portion 225, separately.

As shown in FIGS. 22 to 24, the first guide structure 212 is formed or connected on the inner side of the lower housing 21c. In some examples, the first guide structure 212 and the body of the head housing 21 are formed separately and fixedly connected by screws. In other examples, besides the above connection manner, the first guide structure 212 and the head housing 21 may be connected in another fixed or detachable connection manner such as a snap connection or bonding as long as the first guide structure 212 is connected to the head housing 21 without generating a relative displacement. Alternatively, the first guide structure 212 is integrally formed with the body of the head housing 21. The first guide structure 212 is formed with notches 212a, where the notches 212a correspond to and communicate with the external threading holes 21a one to one for the string trimmer line 53 to penetrate in or out. The whole structure formed by the head housing 21 and the first guide structure 212 is formed with a through hole 21d around the central axis 201 of the head housing 21, where the through hole 21d is used for the operating member 24 to pass through. The first guide structure 212 is formed with a channel around the through hole 21d, where the channel guides the string trimmer line 53 to penetrate through the head housing 21.

In an example, protrusion portions 212b are distributed on the first guide structure 212 and around the through hole 21d, where the protrusion portions 212b divide the accommodation space 210 of the head housing 21 into two areas, which are a threading guide area 210a for the string trimmer line 53 to pass through and a rotation area 210b for the second guide structure 223 to rotate in.

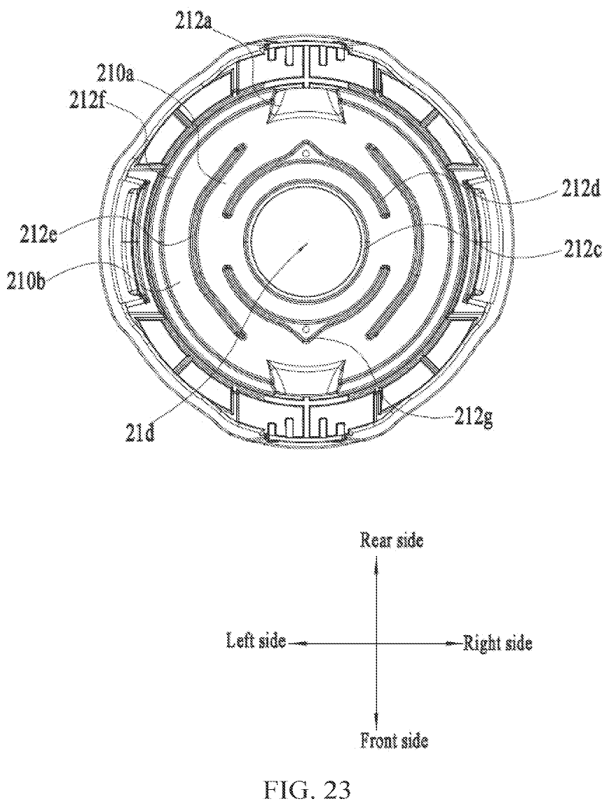

In an example, as shown in FIG. 23, the protrusion portions 212b may include a first protrusion portion 212c, a second protrusion portion 212d, a third protrusion portion 212e, and a fourth protrusion portion 212f, where circles at the positions of the first protrusion portion 212c to the fourth protrusion portion 212f gradually increase in radius, and the first protrusion portion 212c to the fourth protrusion portion 212f are all ridges. The first protrusion portion 212c and the second protrusion portion 212d may constitute a temporary storage area of the string trimmer line 53, the second protrusion portion 212d and the third protrusion portion 212e constitute the threading guide area 210a, and the third protrusion portion 212e and the fourth protrusion portion 212f constitute the rotation area 210b.

The first protrusion portion 212c is a continuous and smooth circle formed around the through hole 21d; the second protrusion portion 212d is a continuous and irregular circular arc or line segment formed around the through hole 21d, the second protrusion portion 212d includes one or more circular arcs or line segments, guide portions 212g for guiding the string trimmer line 53 to be inserted are formed at the notches 212a, a projection of each guide portion 212g on the plane perpendicular to the central axis 201 of the head housing 21 is basically triangular, and the guide portion 212g protrudes from a circle where the second protrusion portion 212d is located. The guide portion 212g may be integrally formed with the second protrusion portion 212d. The guide portion 212g is continuous and smooth to facilitate the insertion of the string trimmer line 53. In some examples, two guide portions 212g are disposed symmetrically about a left and right direction. The two guide portions 212g divide the threading guide area 210a into two sections, and the string trimmer line 53 can pass through both sections. Alternatively, in other examples, one guide section may be closed and only one guide section is opened for the string trimmer line 53 to pass through. The third protrusion portion 212e is a continuous and irregular circular arc formed around the through hole 21d and is broken at the notches 212a, thereby forming two circular arcs symmetrical about a front and rear direction. The fourth protrusion portion 212f is a continuous circular arc formed around the through hole 21d and is broken at the notches 212a to form openings for the string trimmer line 53 to penetrate in or out.

Generally, the user may thread the string trimmer line 53 into the head housing 21 through one external threading hole 21a on the head housing 21 and out through the other external threading hole 21a. However, in the example shown in FIG. 23, multiple protrusion portions may hinder the insertion of the string trimmer line 53 by the user, and the string trimmer line 53 inserted by the user, when colliding with the multiple protrusion portions, may change the direction of the string trimmer line 53 and even return to the original external threading hole 21a through which the string trimmer line 53 is inserted.

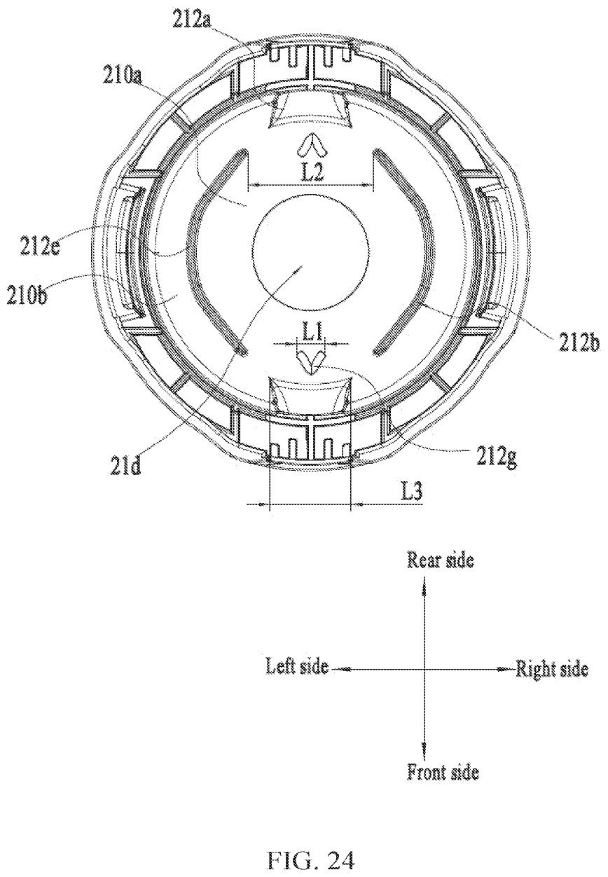

In some examples, as shown in FIG. 24, the protrusion portions 212b may consist of the third protrusion portion 212e and the guide portions 212g to reduce the probability that the string trimmer line 53 inserted by the user changes an extension direction when colliding with the multiple protrusion portions.

Referring to FIG. 24, a minimum distance between the protrusion portion 212b and the through hole 21d of the head housing 21 is greater than or equal to a minimum distance between the guide portion 212g and the through hole 21d. The threading guide area 210a that allows the string trimmer line 53 to pass through may be formed between the protrusion portion 212b and the guide portions 212g. Optionally, a maximum length L1 of the guide portion 212g is smaller than a minimum distance L2 between two circular arcs of the protrusion portion 212b. It is convenient for the string trimmer line 53 to enter the threading guide area 210a between the two circular arcs of the guide portion 212g. Optionally, the minimum distance L2 between the two circular arcs of the protrusion portion 212b is greater than or equal to a maximum length L3 of the notch 212a. It is convenient for the string trimmer line 53 to enter the threading guide area 210a between the two circular arcs of the guide portion 212g after passing through the notch 212a. Optionally, the maximum length L1 of the guide portion 212g is smaller than the maximum length L3 of the notch 212a. If the guide portion 212g is longer than the notch 212a, the string trimmer line 53 is hindered from entering the threading guide area 210a between the two circular arcs of the guide portion 212g after passing through the notch 212a.

In some examples, the operating member 24 and the spool 22 rotate synchronously, and the position of the spool 22 is fixed relative to the head housing 21 in the direction of the central axis 201 of the head housing 21. The operating member 24 is at least partially disposed on the outer side of the head housing 21, and the head housing 21 is further formed with the through hole 21d through which the operating member 24 partially extends into the accommodation space from the outside of the accommodation space 210 along the direction of the central axis 201 of the head housing 21. The operating member 24 can close at least part of the through hole 21d.

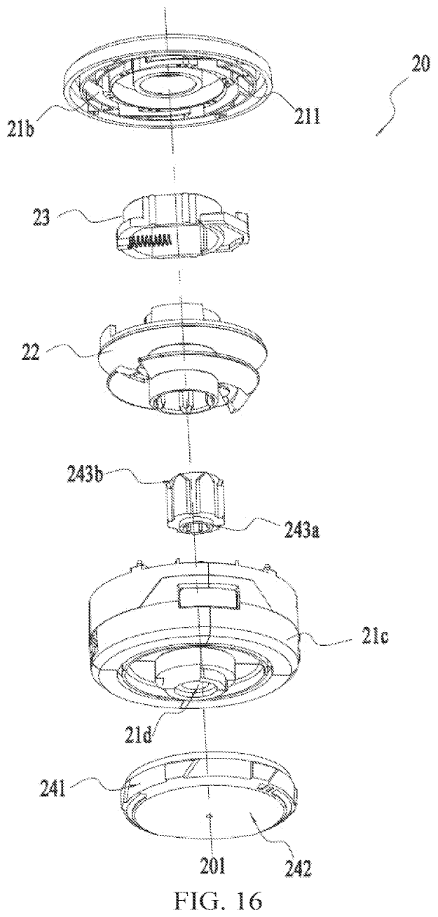

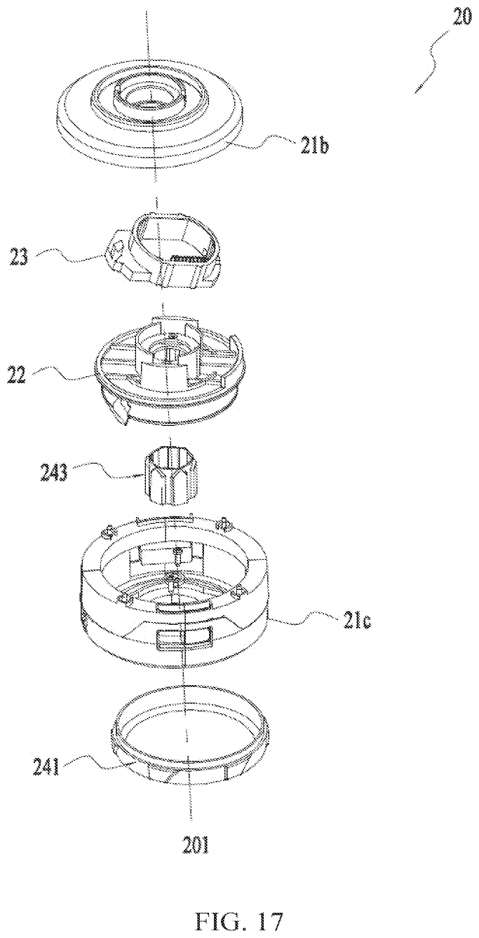

As shown in FIGS. 16 and 17, in some examples, the operating member 24 includes an operating portion 241 for the user to hold and operate. The operating portion 241 is configured to be formed on a portion of the operating member 24 outside the head housing 21 to be convenient for the user to hold and operate. When the user rotates the operating portion 241, the operating member 24 can drive the spool 22 to rotate synchronously with the operating member 24. The operating portion 241 rotates around the head housing 21 and about the central axis 201 of the head housing 21.

The operating portion 241 may surround at least part of the head housing 21 in the circumferential direction around the central axis 201 of the head housing 21 so that the head housing 21 is at least partially disposed in a space surrounded by the operating portion 241. In this manner, the operating portion 241 has a relatively large diameter to be convenient for the user to rotate the operating member 24 more comfortably.

The operating member 24 may include a contact portion 242 for being in contact with the ground when the string trimmer head 20 is trimming grass. The contact portion 242 may be fixedly connected to the operating portion 241. In some examples, the operating portion 241 may be integrally formed with the contact portion 242.

The operating member 24 may further include a connecting portion 243 for connecting the operating member 24 to the spool 22. A first end 243a of the connecting portion 243 is fixedly connected to the contact portion 242, and a second end 243b of the connecting portion 243 is fixedly connected to the spool. In some examples, the connecting portion 243 is fixedly connected to the contact portion 242 by a screw. In some examples, the connecting portion 243 may include a first connecting portion and a second connecting portion. The first connecting portion at least partially penetrates through the through hole 21d of the head housing 21 and is fixedly connected to the contact portion 242. In some examples, the first connecting portion may be integrally formed with the contact portion 242. The second connecting portion is accommodated in the accommodation space 210 of the head housing 21. The first end 243a of the connecting portion 243 is fixedly connected to the contact portion 242, and the second end 243b of the connecting portion 243 is fixedly connected to the spool. Optionally, the fixed connection may be a detachable connection or a non-detachable connection. In some examples, the first connecting portion is fixedly connected to the second connecting portion by a screw. In some examples, the second connecting portion and the spool 22 may be movably connected through bonding, gear engagement, or an interference fit, so as to facilitate the installation and detachment of the string trimmer head 20 by the user. In some examples, the number of parts of the connecting portion for torque transmission between the spool 22 and the operating member 24 is not limited, and one part or multiple parts may be provided. The first connecting portion and the second connecting portion may be understood as two different functional areas of the same part or may be understood as two different functional areas of different parts.

In the preceding example, the user may operate the operating member 24 to drive the spool 22 to rotate relative to the head housing 21: the user holds and rotates the operating portion 241, the operating portion 241 drives the contact portion 242 to rotate, the contact portion 242 drives the connecting portion 243 integrally formed with or fixedly connected to the contact portion 242 to rotate, and the connecting portion 243 drives the spool 22 to rotate so that the spool 22 and the head housing 21 rotate relatively.

In some examples, the operating member 24 may be fixed relative to the spool 22 in the direction of the central axis 201 of the head housing 21, thereby increasing the structural stability of the string trimmer head 20 during trimming and avoiding a structural fault due to the sliding of the operating member 24 relative to the spool 22 in the direction of the central axis 201. Optionally, the operating member 24 is fixed relative to the head housing 21 in the direction of the central axis 201, thereby preventing the operating member 24 from slipping relative to the head housing 21 in the direction of the central axis 201 after touching the ground. Optionally, the spool 22 is fixed relative to the head housing 21 in the direction of the central axis 201, thereby avoiding a structural fault due to the sliding of the head housing 21 relative to the spool 22 in the direction of the central axis 201.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A string trimmer head, comprising:
a spool around which a string trimmer line is capable of being wound;
a head housing having an accommodation space capable of accommodating at least part of the spool;
an automatic line release device configured to enable the spool and the head housing to generate a first relative rotation so that the string trimmer head releases the string trimmer line, wherein the string trimmer line has an effective length extending out of the accommodation space; and the automatic line release device is further configured to make the string trimmer head release the string trimmer line when the effective length of the string trimmer line is less than a preset value; and
an operating member configured to be operable by a user to drive the spool and the head housing to generate a second relative rotation so that the string trimmer line is wound around the spool.

2. The string trimmer head according to claim 1, wherein the head housing is provided with a through hole along a central axis, part of the operating member penetrates through the through hole and enters the accommodation space of the head housing, and the operating member rotates synchronously with the spool.

3. The string trimmer head according to claim 2, wherein the operating member is fixedly connected to the spool.

4. The string trimmer head according to claim 3, wherein the operating member is fixed relative to the spool in a direction of the central axis.

5. The string trimmer head according to claim 2, wherein the operating member is fixed relative to the head housing in a direction of the central axis.

6. The string trimmer head according to claim 2, wherein the spool is fixed relative to the head housing in a direction of the central axis.

7. The string trimmer head according to claim 1, wherein, when the string trimmer head is in a state of the first relative rotation, the spool rotates about a central axis of the head housing and relative to the head housing along a first direction, or the head housing rotates about the central axis and relative to the spool along the first direction; and, when the string trimmer head is in a state of the second relative rotation, the spool rotates about the central axis and relative to the head housing along a second direction, or the head housing rotates about the central axis and relative to the spool along the second direction; wherein the first direction is opposite to the second direction.

8. The string trimmer head according to claim 2, wherein the operating member comprises:
an operating portion for the user to hold;
a contact portion for being in contact with the ground when the string trimmer head is trimming grass and fixedly connected to the operating portion; and
a connecting portion at least partially penetrating through the through hole and accommodated in the accommodation space of the head housing, wherein a first end of the connecting portion is fixedly connected to the contact portion, and a second end of the connecting portion is fixedly connected to the spool.

9. The string trimmer head according to any one of claim 1, wherein the head housing comprises a first guide structure configured to guide the string trimmer line to penetrate through the head housing without entering the spool during threading, and the spool comprises a second guide structure configured to guide the string trimmer line to leave the first guide structure and be wound around the spool through the second relative rotation between the spool and the head housing during winding.

10. The string trimmer head according to claim 9, wherein the first guide structure comprises:
notches for the string trimmer line to penetrate into or out of the head housing;
a protrusion portion used for forming a threading channel for guiding the string trimmer line to penetrate through the head housing, configured to be at least two circular arcs formed around a through hole of the head housing, and broken at the notches; and
guide portions, used for guiding the string trimmer line to penetrate into the head housing, formed at the notches.

11. The string trimmer head according to claim 1, wherein the automatic line release device is configured to switch between an autonomous line release state for allowing a line release of the string trimmer head and a trimming state for preventing the line release of the string trimmer head based on a change of the effective length of the string trimmer line.

12. The string trimmer head according to claim 1, wherein the operating member is configured to be operated by the user to drive the head housing to rotate.

13. The string trimmer head according to claim 1, wherein the operating member is configured to be operated by the user to drive the spool to rotate.

14. The string trimmer head according to claim 1, wherein the automatic line release device comprises a transmission member capable of switching between a first position and a second position, when the transmission member is at the first position, the automatic line release device prevents a relative rotation between the spool and the head housing, and, when the transmission member is at the second position, the automatic line release device allows the relative rotation between the spool and the head housing.

15. The string trimmer head according to claim 14, wherein the transmission member rotates synchronously with the spool and comprises a drive portion for driving the head housing to rotate, the head housing comprises a mating portion mating with the drive portion, the head housing comprises an upper housing and a lower housing, and the mating portion is disposed on a lower side of the upper housing.

16. A string trimmer, comprising a string trimmer head and a motor for driving the string trimmer head to rotate, wherein the string trimmer head comprises:
a spool around which a string trimmer line is capable of being wound; and
a head housing having an accommodation space capable of accommodating at least part of the spool;
wherein the string trimmer head further comprises:
an automatic line release device configured to enable the spool and the head housing to generate a first relative rotation so that the string trimmer head releases the string trimmer line, wherein the string trimmer line has an effective length extending out of the accommodation space; and the automatic line release device is further configured to make the string trimmer head release the string trimmer line when the effective length of the string trimmer line is less than a preset value; and
an operating member configured to be operable by a user to drive the spool and the head housing to generate a second relative rotation so that the string trimmer line is wound around the spool.

17. The string trimmer according to claim 16, further comprising the motor for driving the string trimmer head to rotate, wherein the automatic line release device comprises a transmission member having, relative to the spool, a first position for preventing a relative rotation between the spool and the head housing and a second position for allowing the relative rotation between the spool and the head housing, and, when the transmission member is at the first position, the string trimmer head is in a trimming state and the motor has a first rotational speed, when the transmission member is at the second position, the string trimmer head is in an autonomous line release state, the motor has a second rotational speed with a difference from the first rotational speed, and the spool and the head housing generate the first relative rotation to release the string trimmer line, when the effective length of the string trimmer line is greater than or equal to the preset value, the transmission member is at the first position, and, when the effective length of the string trimmer line is less than the preset value, the transmission member is at the second position.

18. A string trimmer head, comprising:
a spool around which a string trimmer line is capable of being wound;
a head housing having an accommodation space capable of accommodating at least part of the spool;
an automatic line release device configured to enable the spool and the head housing to generate a first relative rotation so that the string trimmer head releases the string trimmer line, wherein the string trimmer line has an effective length extending out of the accommodation space; and the automatic line release device is further configured to make the string trimmer head release the string trimmer line when the effective length of the string trimmer line is less than a preset value;
a first guide structure formed on or connected to the head housing and configured to guide the string trimmer line to penetrate through the head housing without entering the spool during threading; and
a second guide structure formed on or connected to the spool and configured to guide the string trimmer line to leave the first guide structure and be wound around the spool through a relative rotation between the spool and the head housing during winding.

19. The string trimmer head according to claim 18, wherein the first guide structure and the second guide structure are disposed on a lower side of the spool, and the automatic line release device is disposed on an upper side of the spool.

20. The string trimmer head according to claim 18, wherein the first guide structure comprises:
notches for the string trimmer line to penetrate into or out of the head housing;
a protrusion portion used for forming a threading channel for guiding the string trimmer line to penetrate through the head housing, configured to be at least two circular arcs formed around a through hole of the head housing, and broken at the notches; and
guide portions, used for guiding the string trimmer line to penetrate into the head housing, formed at the notches.
